(19) United States
(12) Patent Application Publication
(10) Pub. No.: US 2025/0264698 A1
(43) Pub. Date: Aug. 21, 2025

(54) IMAGING OPTICAL SYSTEM, AND IMAGE CAPTURE DEVICE AND CAMERA SYSTEM INCLUDING THE SAME

(71) Applicant: Panasonic Intellectual Property Management Co., Ltd., Osaka (JP)

(72) Inventors: Yuka IKEGAMI, Hyogo (JP); Takehiro NISHIOKA, Nara (JP); Yoshiaki KURIOKA, Osaka (JP); Kunio DOHNO, Osaka (JP)

(21) Appl. No.: 19/057,284

(22) Filed: Feb. 19, 2025

(30) Foreign Application Priority Data
Feb. 20, 2024 (JP) 2024-023382

(51) Int. Cl. G02B 13/00; G02B 7/02; G02B 15/14; G02B 27/64; G03B 5/04; G03B 17/14

(52) U.S. Cl. CPC G02B 13/009; G02B 7/021; G02B 7/025; G02B 13/006; G02B 15/1461; G02B 27/646; G03B 5/04; G03B 17/14

(57) ABSTRACT

An imaging optical system includes: a first lens group having positive power; a second lens group having negative power; a third lens group having positive power; a fourth lens group having positive power; a fifth lens group having negative power; and a sixth lens group having power. The first, second, third, fourth, fifth, and sixth lens groups are arranged in this order such that the first lens group is located closest to an object and that the sixth lens group is located closest to an image plane. An interval between each pair of lens groups that are adjacent to each other changes as at least the first, second, third, fourth, fifth, and sixth lens groups move in an optical axis direction aligned with an optical axis of the imaging optical system while the imaging optical system is zooming.

### CROSS-REFERENCE TO RELATED APPLICATIONS

The present application is based upon, and claims the benefit of priority to, Japanese Patent Application No. 2024-023382, filed on Feb. 20, 2024, the entire contents of which are hereby incorporated by reference.

### TECHNICAL FIELD

The present disclosure relates to an imaging optical system having the ability to compensate for various types of aberrations sufficiently over the entire zoom range, and also relates to an image capture device and interchangeable lens unit including such an imaging optical system.

### BACKGROUND ART

JP 2023-104137 A discloses a zoom lens including a first lens group L1 having positive refractive power, a second lens group L2 having negative refractive power, a third lens group L3 having positive refractive power, a fourth lens group L4 having positive refractive power, and an N^{th} lens group LN having negative refractive power. The first, second, third, fourth, and N^{th} lens groups L1, L2, L3, L4, and LN are arranged in this order such that the first lens group L1 is located closer to an object than any of the other second, third, fourth, and N^{th} lens groups is, and that the N^{th} lens group is located closer to an image plane than any of the other first, second, third, and fourth lens groups is. In the zoom lens, the interval between adjacent lens groups changes while the zoom lens system is zooming.

### SUMMARY

The present disclosure provides an imaging optical system having the ability to compensate for various types of aberrations sufficiently over the entire zoom range and an image capture device and interchangeable lens unit including such an imaging optical system. An imaging optical system according to the present disclosure includes: a first lens group having positive power; a second lens group having negative power; a third lens group having positive power; a fourth lens group having positive power; a fifth lens group having negative power; and a sixth lens group having power. The first, second, third, fourth, fifth, and sixth lens groups are arranged in this order such that the first lens group is located closer to an object than any of the second, third, fourth, fifth or sixth lens group is, and that the sixth lens group is located closer to an image plane than any of the first, second, third, fourth, or fifth lens group is. An interval between each pair of lens groups that are adjacent to each other changes as at least the first, second, third, fourth, fifth, and sixth lens groups move in an optical axis direction aligned with an optical axis of the imaging optical system while the imaging optical system is zooming.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1A illustrates lens arrangements showing an infinity in-focus state of an imaging optical system according to a first embodiment (corresponding to a first example of numerical values);

FIG. 1B illustrates longitudinal aberration diagrams showing the infinity in-focus state of the imaging optical system in the first example of numerical values;

FIG. 1C illustrates lateral aberration diagrams showing a basic state where the imaging optical system is making no image blur compensation and an image blur compensated state where the imaging optical system is making image blur compensation, respectively, at a telephoto end in the first example of numerical values;

FIG. 2A illustrates lens arrangements showing an infinity in-focus state of an imaging optical system according to a second embodiment (corresponding to a second example of numerical values);

FIG. 2B illustrates longitudinal aberration diagrams showing the infinity in-focus state of the imaging optical system in the second example of numerical values;

FIG. 2C illustrates lateral aberration diagrams showing a basic state where the imaging optical system is making no image blur compensation and an image blur compensated state where the imaging optical system is making image blur compensation, respectively, at a telephoto end in the second example of numerical values;

FIG. 3A illustrates lens arrangements showing an infinity in-focus state of an imaging optical system according to a third embodiment (corresponding to a third example of numerical values);

FIG. 3B illustrates longitudinal aberration diagrams showing the infinity in-focus state of the imaging optical system in the third example of numerical values;

FIG. 3C illustrates lateral aberration diagrams showing a basic state where the imaging optical system is making no image blur compensation and an image blur compensated state where the imaging optical system is making image blur compensation, respectively, at a telephoto end in the third example of numerical values;

FIG. 4A illustrates lens arrangements showing an infinity in-focus state of an imaging optical system according to a fourth embodiment (corresponding to a fourth example of numerical values);

FIG. 4B illustrates longitudinal aberration diagrams showing the infinity in-focus state of the imaging optical system in the fourth example of numerical values;

FIG. 4C illustrates lateral aberration diagrams showing a basic state where the imaging optical system is making no image blur compensation and an image blur compensated state where the imaging optical system is making image blur compensation, respectively, at a telephoto end in the fourth example of numerical values;

FIG. 5A illustrates lens arrangements showing an infinity in-focus state of an imaging optical system according to a fifth embodiment (corresponding to a fifth example of numerical values);

FIG. 5B illustrates longitudinal aberration diagrams showing the infinity in-focus state of the imaging optical system in the fifth example of numerical values;

FIG. 5C illustrates lateral aberration diagrams showing a basic state where the imaging optical system is making no image blur compensation and an image blur compensated state where the imaging optical system is making image blur compensation, respectively, at a telephoto end in the fifth example of numerical values;

FIG. 6 illustrates a schematic configuration for an image capture device according to the first embodiment; and

FIG. 7 illustrates a schematic configuration for a camera system according to the first embodiment.

### DETAILED DESCRIPTION

Embodiments of the present disclosure will now be described in detail with reference to the accompanying drawings as needed. Note that unnecessarily detailed description will be omitted. For example, detailed description of already well-known matters and redundant description of substantially the same configuration will be omitted. This is done to avoid making the following description overly redundant and thereby help one of ordinary skill in the art understand the present disclosure easily.

In addition, note that the accompanying drawings and the following description are provided to help one of ordinary skill in the art understand the present disclosure fully and should not be construed as limiting the scope of the present disclosure, which is defined by the appended claims.

### First to Fifth Embodiments

Imaging optical systems according to first to fifth embodiments will now be described on an individual basis with reference to the accompanying drawings.

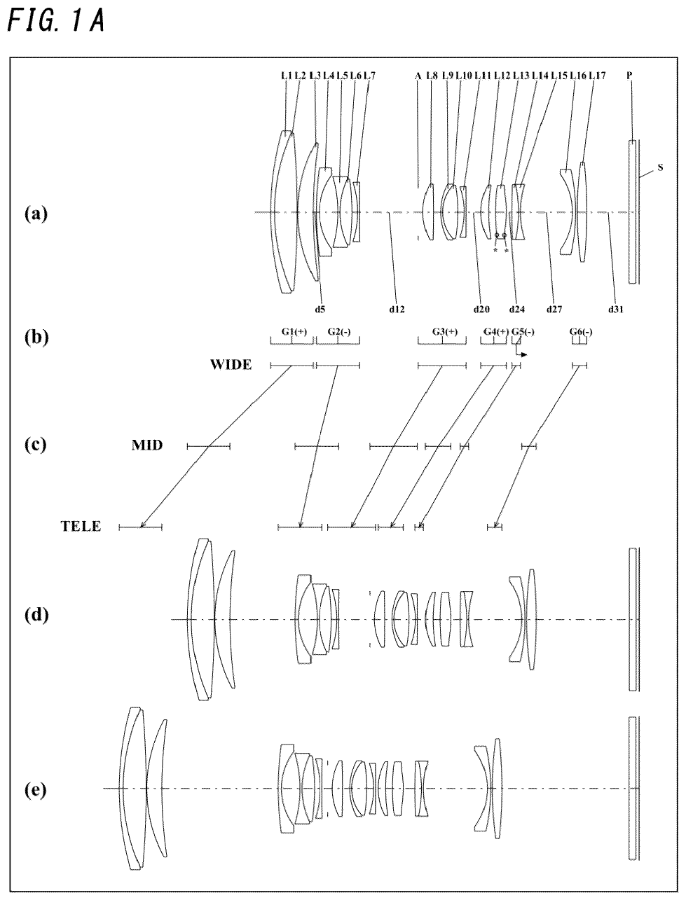

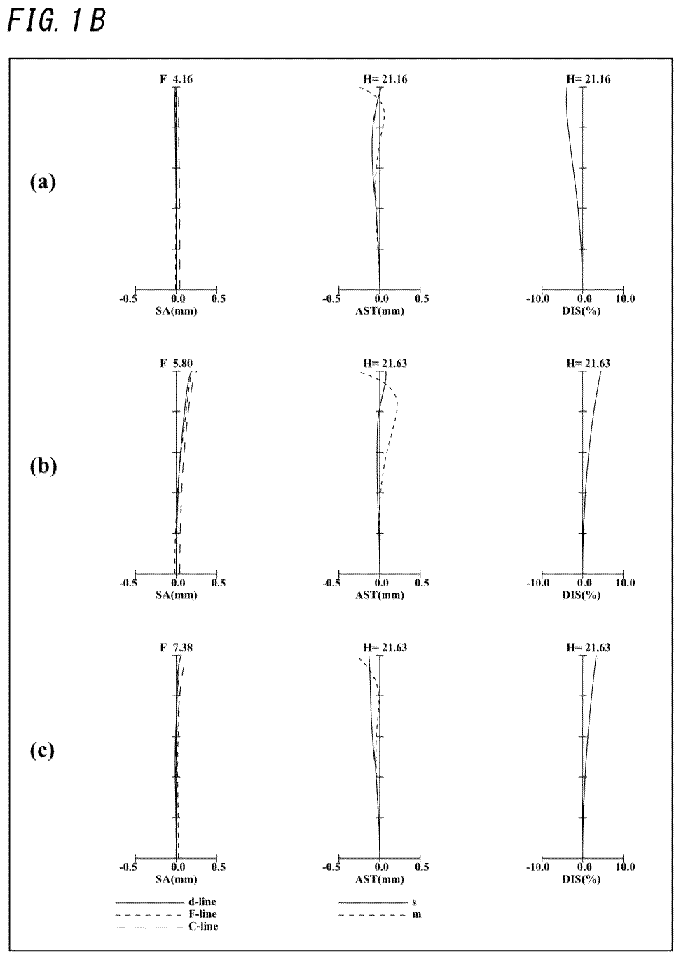

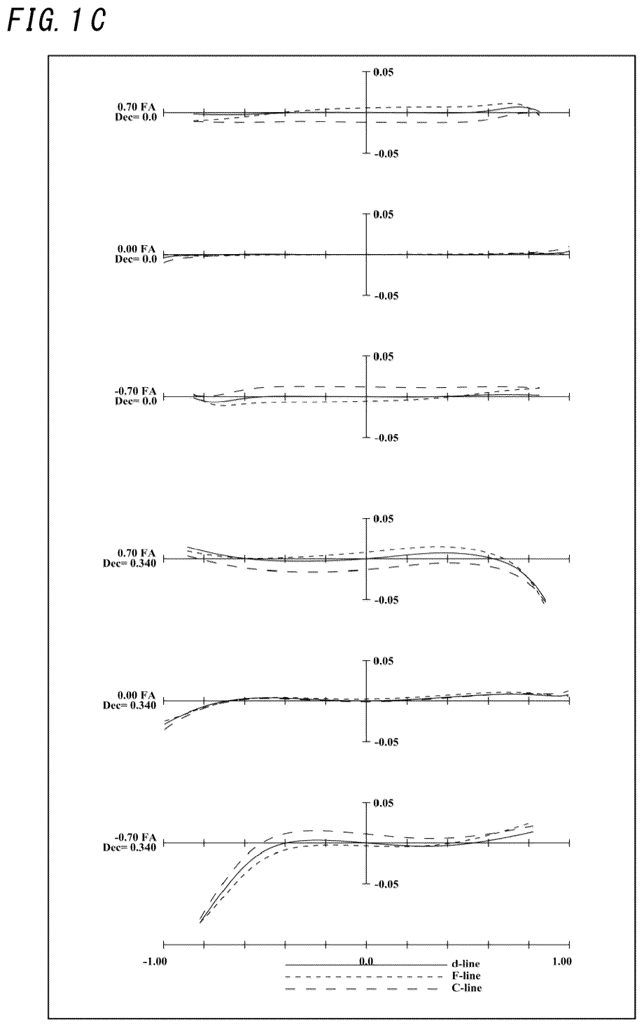

FIGS. 1A, 2A, 3A, 4A, and 5A illustrate lens arrangements of imaging optical systems according to first to fifth embodiments, respectively. In each of FIGS. 1A, 2A, 3A, 4A, and 5A, the imaging optical system is in an infinity in-focus state.

In FIGS. 1A, 2A, 3A, 4A, and 5A, portion (a) illustrates a lens arrangement at a wide-angle end (which is a state with the shortest focal length fw); portion (d) illustrates a lens arrangement at a middle position (which is a state with a middle focal length fM=√(fw*fT)); and portion (e) illustrates a lens arrangement at a telephoto end (which is a state with the longest focal length fT). Note that portions (a), (d), and (e) of FIGS. 1A, 2A, 3A, 4A, and 5A have the same aspect ratio.

Furthermore, in portion (a) of FIGS. 1A, 2A, 3A, 4A, and 5A, the asterisk (*) attached to a surface of a particular lens indicates that the surface is an aspheric surface. Note that in the lenses shown in portion (a) of FIGS. 1A, 2A, 3A, 4A, and 5A, an object-side surface or an image-side surface having no asterisks is a spherical surface.

Also, in FIGS. 1A, 2A, 3A, 4A, and 5A, the polygon arrows shown in portion (c) thereof each connect together the respective positions of the lens groups at the wide-angle end (WIDE), middle position (MID), and telephoto end (TELE) from top to bottom. Note that these polygon arrows just connect the wide-angle end to the middle position and the middle position to the telephoto end with the lines, and do not indicate the actual movement of the lens groups.

Furthermore, in portion (b) of FIGS. 1A, 2A, 3A, 4A, and 5A, the respective lens groups are designated by the reference signs G1-G6 (or G1-G7) corresponding to their respective positions shown in portion (a).

Furthermore, the signs (+) and (−) added to the reference signs G1-G7 of the respective lens groups in portion (b) of FIGS. 1A, 2A, 3A, 4A, and 5A indicate the powers of the respective lens groups G1-G7. That is to say, the positive sign (+) indicates positive power, and the negative sign (−) indicates negative power.

Also, the arrows added to the lens groups in portion (b) of FIGS. 1A, 2A, 3A, 4A, and 5A each indicate focusing to make a transition from the infinity in-focus state toward the close-object in-focus state. Note that in FIGS. 1A, 2A, 3A, 4A, and 5A, the reference signs of respective lens groups are shown under the respective lens groups in portion (a) thereof, and therefore, an arrow indicating focusing is shown under the sign of each lens group for convenience's sake. In each zooming state, the directions of movement of the respective lens groups during focusing will be described more specifically later with respect to each of the first through fifth embodiments.

Furthermore, in portions (a), (d), and (e) of FIGS. 1A, 2A, 3A, 4A, and 5A, the straight line drawn at the right end indicates the position of the image plane S (i.e., a surface, facing the object, of the image sensor). Therefore, the left end of the drawings corresponds to the object side. Furthermore, a parallel plate P such as a low-pass filter or cover glass is disposed between the lens group on the last stage, facing the image plane S, of the imaging optical system and the image plane S.

Note that the “optical axis” as used herein refers to the “optical axis of the imaging optical system” unless otherwise stated.

### First Embodiment

FIG. 1A illustrates an imaging optical system according to a first embodiment.

The imaging optical system includes: a first lens group G1 having positive power; a second lens group G2 having negative power; a third lens group G3 having positive power; a fourth lens group G4 having positive power; a fifth lens group G5 having negative power; and a sixth lens group G6 having negative power. The first, second, third, fourth, fifth, and sixth lens groups G1, G2, G3, G4, G5, G6 are arranged in this order such that the first lens group G1 is located closer to an object than any of the second, third, fourth, fifth, or sixth lens group G2, G3, G4, G5, G6 is and that the sixth lens group G6 is located closer to an image plane than any of the first, second, third, fourth, or fifth lens group G1, G2, G3, G4, G5 is.

The imaging optical system forms an image at a point on the image plane S.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is. The first lens L1 and the second lens L2 are bonded together with an adhesive, for example, to form a bonded lens. That is to say, the bonded lens includes the first lens L1 and the second lens L2.

The second lens group G2 is made up of: a fourth lens L4 having negative power; a fifth lens L5 having negative power; a sixth lens L6 having positive power; and a seventh lens L7 having negative power. The fourth, fifth, sixth, and seventh lenses L4, L5, L6, L7 are arranged in this order such that the fourth lens L4 is located closer to the object than any other member of this second lens group G2 is and that the seventh lens L7 is located closer to the image plane than any other member of this second lens group G2 is. The fifth lens L5 and the sixth lens L6 are bonded together with an adhesive, for example, to form a bonded lens. That is to say, the bonded lens includes the fifth lens L5 and the sixth lens L6.

The third lens group G3 is made up of: an aperture stop A; an eighth lens L8 having positive power; a ninth lens L9 having negative power; a tenth lens L10 having positive power; and an eleventh lens L11 having negative power. The aperture stop A and the eighth, ninth, tenth, and eleventh lenses L8, L9, L10, L11 are arranged in this order such that the aperture stop A is located closer to the object than any other member of this third lens group G3 is and that the eleventh lens L11 is located closer to the image plane than any other member of this third lens group G3 is. The ninth lens L9 and the tenth lens L10 are bonded together with an adhesive, for example, to form a bonded lens. That is to say, the bonded lens includes the ninth lens L9 and the tenth lens L10.

The fourth lens group G4 is made up of a twelfth lens L12 having positive power and a thirteenth lens L13 having positive power. The twelfth lens L12 is located closer to the object than the thirteenth lens L13 is. The thirteenth lens L13 is located closer to the image plane than the twelfth lens L12 is.

The fifth lens group G5 is made up of: a fourteenth lens L14 having positive power; and a fifteenth lens L5 having negative power. The fourteenth lens L14 is located closer to the object than the fifteenth lens L15 is. The fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having negative power and a seventeenth lens L17 having positive power. The sixteenth lens L16 is located closer to the object than the seventeenth lens L17 is. The seventeenth lens L17 is located closer to the image plane than the sixteenth lens L16 is.

The respective lenses will be described.

First, the respective lenses that form the first lens group G1 will be described. The first lens L1 is a meniscus lens having a convex surface facing the object. The second lens L2 is a biconvex lens. The third lens L3 is a meniscus lens having a convex surface facing the object.

Next, the respective lenses that form the second lens group G2 will be described. The fourth lens L4 is a meniscus lens having a convex surface facing the object. The fifth lens L5 is a biconcave lens. The sixth lens L6 is a biconvex lens. The seventh lens L7 is a biconcave lens.

Next, the respective lenses that form the third lens group G3 will be described. The eighth lens L8 is a biconvex lens. The ninth lens L9 is a meniscus lens having a convex surface facing the object. The tenth lens L10 is a biconvex lens. The eleventh lens L11 is a meniscus lens having a convex surface facing the image plane. In this case, the eighth lens L8 is an example of the lens LG3F1. The eighth lens L8 is an example of the group of fixed lenses G3Obj configured not to move perpendicularly to the optical axis during image stabilization. The ninth lens L9 is an example of the lens LG3F2. The ninth lens L9 and the tenth lens L10 are an example of a group of image stabilizer lenses that move perpendicularly to the optical axis during the image stabilization. The eleventh lens L11 is an example of the lens LG3R1. The eleventh lens L11 is an example of a group of fixed lenses G3Img that does not move perpendicularly to the optical axis during the image stabilization.

Next, the respective lenses that form the fourth lens group G4 will be described. The twelfth lens L12 is a meniscus lens having a convex surface facing the object. The thirteenth lens L13 is a biconvex lens. The object-side and image-side surfaces of the thirteenth lens L13 are aspheric surfaces. In this case, the twelfth lens L12 is an example of the lens LG4F1. The twelfth lens L12 is an example of the lens LG4Fp1. The thirteenth lens L13 is an example of the lens LG4F2.

Next, the respective lenses that form the fifth lens group G5 will be described. The fourteenth lens L14 is a biconvex lens. The fifteenth lens L15 is a biconcave lens.

Next, the respective lenses that form the sixth lens group G6 will be described. The sixteenth lens L16 is a meniscus lens having a convex surface facing the image plane. The seventeenth lens L17 is a biconvex lens.

While the imaging optical system according to the first embodiment is zooming from the wide-angle end toward the telephoto end during a shooting session, the first lens group G1, the second lens group G2, the third lens group G3, the fourth lens group G4, the fifth lens group G5, and the sixth lens group G6 all move toward the object with respect to the image plane S. In the meantime, as the imaging optical system is zooming, the first, second, third, fourth, fifth, and sixth lens groups G1, G2, G3, G4, G5, G6 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 increases, and the interval between the fifth lens group G5 and the sixth lens group G6 increases.

While the imaging optical system according to the first embodiment is focusing to make a transition from the infinity in-focus state toward the close-object in-focus state, the fifth lens group G5 moves along the optical axis toward the image plane.

When any camera shake or any vibration caused by external force during a shooting session is detected by a gyrosensor provided for at least one of an interchangeable lens unit holding the imaging optical system or an image capture device to which the interchangeable lens unit is attached, the ninth lens L9 and the tenth lens L10 (forming the group of image stabilizer lenses) which belong to the third lens group G3 move perpendicularly to the optical axis (i.e., in a direction in which the image blur is reduced) to optically compensate for the image blur that may be caused by the camera shake or the vibration due to external force. These image blur compensation lenses (namely, the ninth lens L9 and the tenth lens L10) allow the imaging optical system to compensate for the shift of the image point due to the vibration of the overall system. That is to say, this allows the imaging optical system to optically compensate for the image blur due to camera shake, vibrations, and other disturbances.

### Second Embodiment

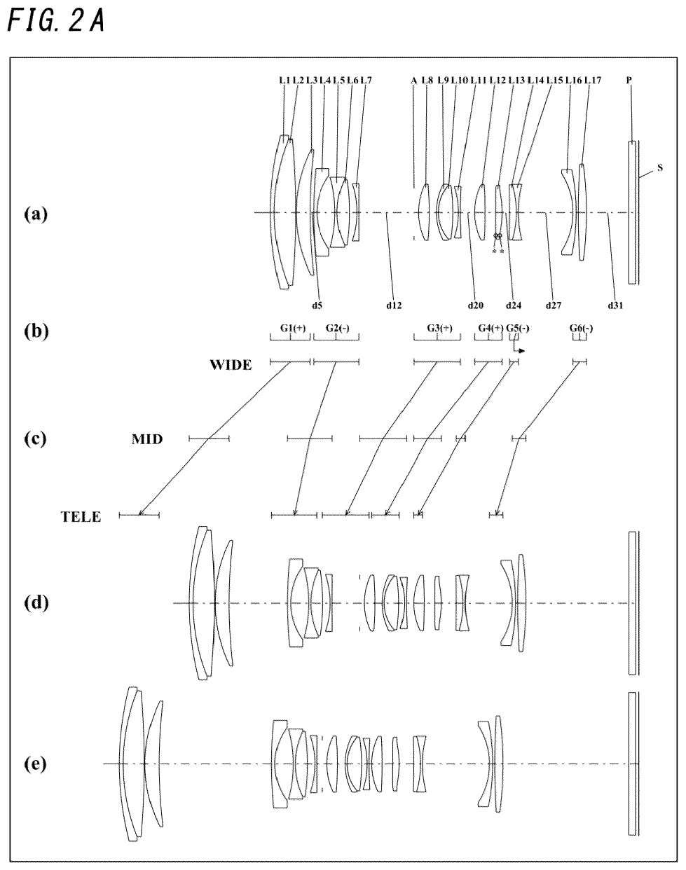

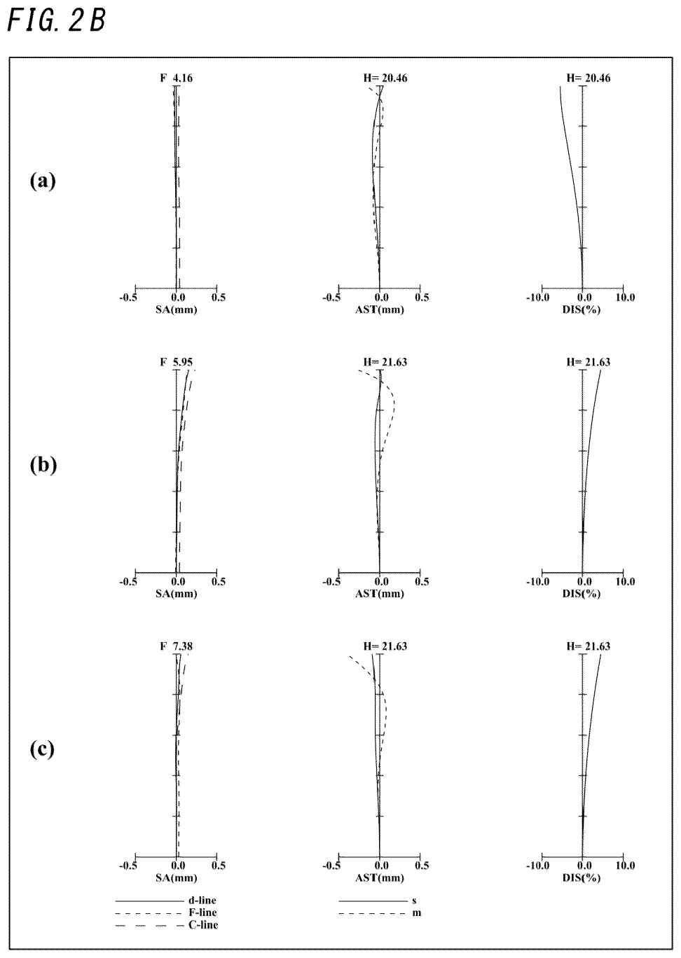

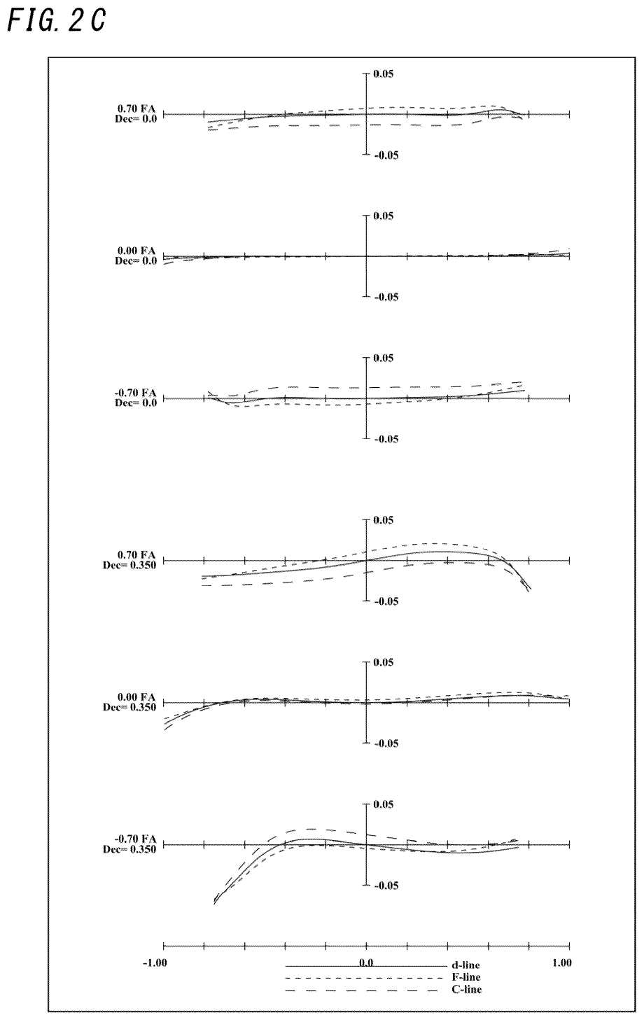

FIG. 2A illustrates an imaging optical system according to a second embodiment.

The imaging optical system includes: a first lens group G1 having positive power; a second lens group G2 having negative power; a third lens group G3 having positive power; a fourth lens group G4 having positive power; a fifth lens group G5 having negative power; and a sixth lens group G6 having negative power. The first, second, third, fourth, fifth, and sixth lens groups G1, G2, G3, G4, G5, G6 are arranged in this order such that the first lens group G1 is located closer to an object than any of the second, third, fourth, fifth, or sixth lens group G2, G3, G4, G5, G6 is and that the sixth lens group G6 is located closer to an image plane than any of the first, second, third, fourth, or fifth lens group G1, G2, G3, G4, G5 is.

The imaging optical system forms an image at a point on the image plane S.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is. The first lens L1 and the second lens L2 are bonded together with an adhesive, for example, to form a bonded lens. That is to say, the bonded lens includes the first lens L1 and the second lens L2.

The second lens group G2 is made up of: a fourth lens L4 having negative power; a fifth lens L5 having negative power; a sixth lens L6 having positive power; and a seventh lens L7 having negative power. The fourth, fifth, sixth, and seventh lenses L4, L5, L6, L7 are arranged in this order such that the fourth lens L4 is located closer to the object than any other member of this second lens group G2 is and that the seventh lens L7 is located closer to the image plane than any other member of this second lens group G2 is. The fifth lens L5 and the sixth lens L6 are bonded together with an adhesive, for example, to form a bonded lens. That is to say, the bonded lens includes the fifth lens L5 and the sixth lens L6.

The third lens group G3 is made up of: an aperture stop A; an eighth lens L8 having positive power; a ninth lens L9 having negative power; a tenth lens L10 having positive power, and an eleventh lens L11 having negative power. The aperture stop A and the eighth, ninth, tenth, and eleventh lenses L8, L9, L10, L11 are arranged in this order such that the aperture stop A is located closer to the object than any other member of this third lens group G3 is and that the eleventh lens L11 is located closer to the image plane than any other member of this third lens group G3 is. The ninth lens L9 and the tenth lens L10 are bonded together with an adhesive, for example, to form a bonded lens. That is to say, the bonded lens includes the ninth lens L9 and the tenth lens L10.

The fourth lens group G4 is made up of a twelfth lens L12 having positive power and a thirteenth lens L13 having positive power. The twelfth lens L12 is located closer to the object than the thirteenth lens L13 is. The thirteenth lens L13 is located closer to the image plane than the twelfth lens L12 is.

The fifth lens group G5 is made up of: a fourteenth lens L14 having positive power; and a fifteenth lens L5 having negative power. The fourteenth lens L14 is located closer to the object than the fifteenth lens L15 is. The fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having negative power and a seventeenth lens L17 having positive power. The sixteenth lens L16 is located closer to the object than the seventeenth lens L17 is. The seventeenth lens L17 is located closer to the image plane than the sixteenth lens L16 is.

The respective lenses will be described.

First, the respective lenses that form the first lens group G1 will be described. The first lens L1 is a meniscus lens having a convex surface facing the object. The second lens L2 is a biconvex lens. The third lens L3 is a meniscus lens having a convex surface facing the object.

Next, the respective lenses that form the second lens group G2 will be described. The fourth lens L4 is a meniscus lens having a convex surface facing the object. The fifth lens L5 is a biconcave lens. The sixth lens L6 is a biconvex lens. The seventh lens L7 is a biconcave lens.

Next, the respective lenses that form the third lens group G3 will be described. The eighth lens L8 is a biconvex lens. The ninth lens L9 is a meniscus lens having a convex surface facing the object. The tenth lens L10 is a biconvex lens. The eleventh lens L11 is a biconcave lens. In this case, the eighth lens L8 is an example of the lens LG3F1. The eighth lens L8 is an example of the group of fixed lenses G3Obj configured not to move perpendicularly to the optical axis during image stabilization. The ninth lens L9 is an example of the lens LG3F2. The ninth lens L9 and the tenth lens L10 are an example of a group of image stabilizer lenses that move perpendicularly to the optical axis during the image stabilization. The eleventh lens L11 is an example of the lens LG3R1. The eleventh lens L11 is an example of a group of fixed lenses G3Img that does not move perpendicularly to the optical axis during the image stabilization.

Next, the respective lenses that form the fourth lens group G4 will be described. The twelfth lens L12 is a biconvex lens. The thirteenth lens L13 is a biconvex lens. The object-side and image-side surfaces of the thirteenth lens L13 are aspheric surfaces. In this case, the twelfth lens L12 is an example of the lens LG4F1. The twelfth lens L12 is an example of the lens LG4Fp1. The thirteenth lens L13 is an example of the lens LG4F2.

Next, the respective lenses that form the fifth lens group G5 will be described. The fourteenth lens L14 is a meniscus lens having a convex surface facing the image plane. The fifteenth lens L15 is a biconcave lens.

Next, the respective lenses that form the sixth lens group G6 will be described. The sixteenth lens L16 is a meniscus lens having a convex surface facing the image plane. The seventeenth lens L17 is a biconvex lens.

While the imaging optical system according to the second embodiment is zooming from the wide-angle end toward the telephoto end during a shooting session, the first lens group G1, the second lens group G2, the third lens group G3, the fourth lens group G4, the fifth lens group G5, and the sixth lens group G6 all move toward the object with respect to the image plane S. In the meantime, as the imaging optical system is zooming, the first, second, third, fourth, fifth, and sixth lens groups G1, G2, G3, G4, G5, G6 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 increases from the wide-angle end through a middle position but decreases from the middle position through the telephoto end, and the interval between the fifth lens group G5 and the sixth lens group G6 decreases from the wide-angle end through the middle position but increases from the middle position through the telephoto end.

While the imaging optical system according to the second embodiment is focusing to make a transition from the infinity in-focus state toward the close-object in-focus state, the fifth lens group G5 moves along the optical axis toward the image plane.

Meanwhile, the ninth lens L9 and the tenth lens L10 (forming the group of image stabilizer lenses) which belong to the third lens group G3 move perpendicularly to the optical axis to optically compensate for the image blur. These image blur compensation lenses (namely, the ninth lens L9 and the tenth lens L10) allow the imaging optical system to compensate for the shift of the image point due to the vibration of the overall system. That is to say, this allows the imaging optical system to optically compensate for the image blur due to camera shake, vibrations, and other disturbances.

### Third Embodiment

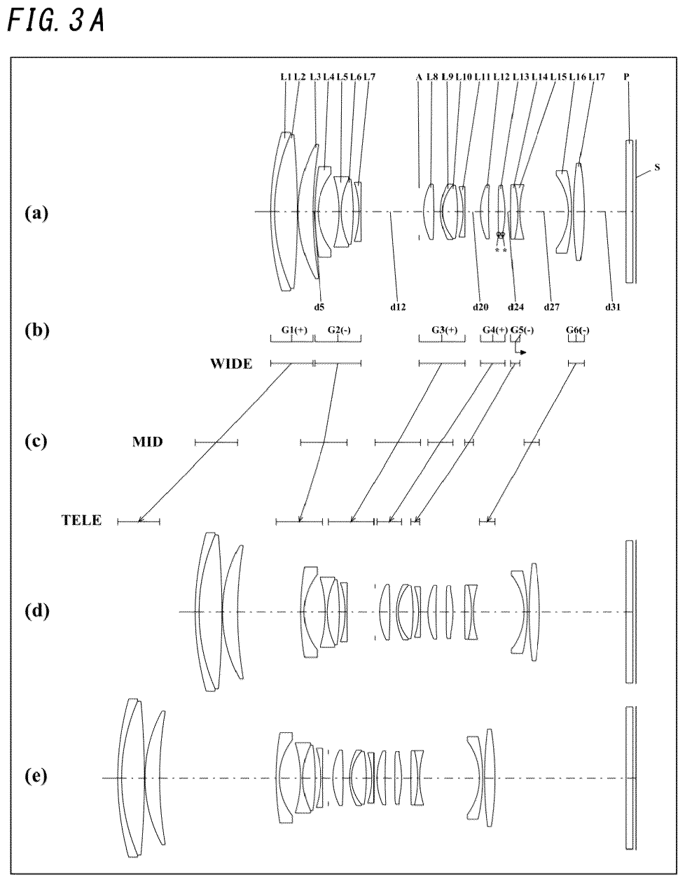

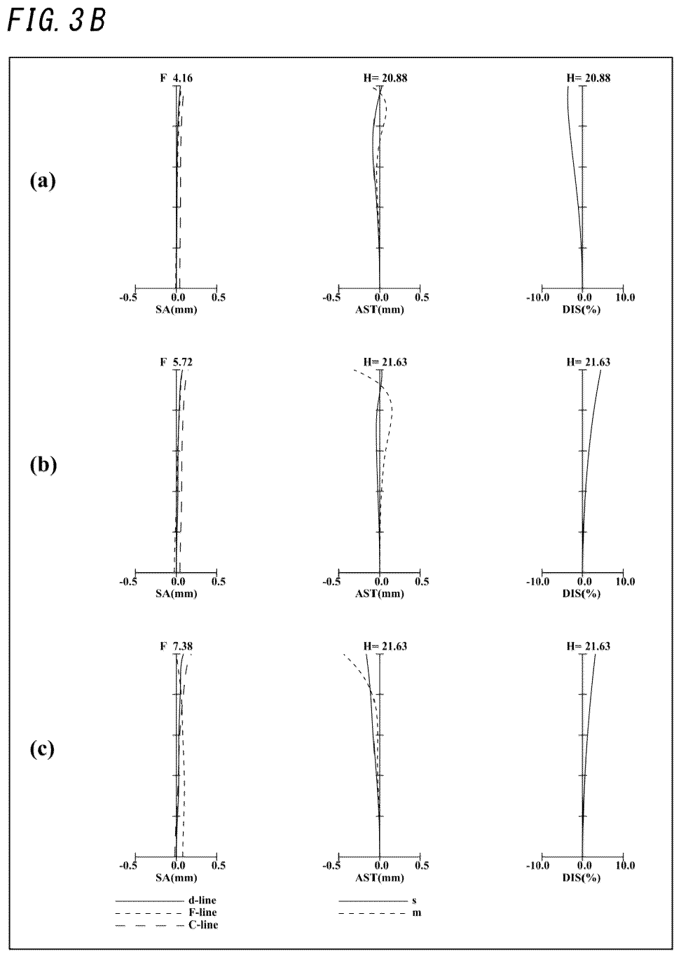

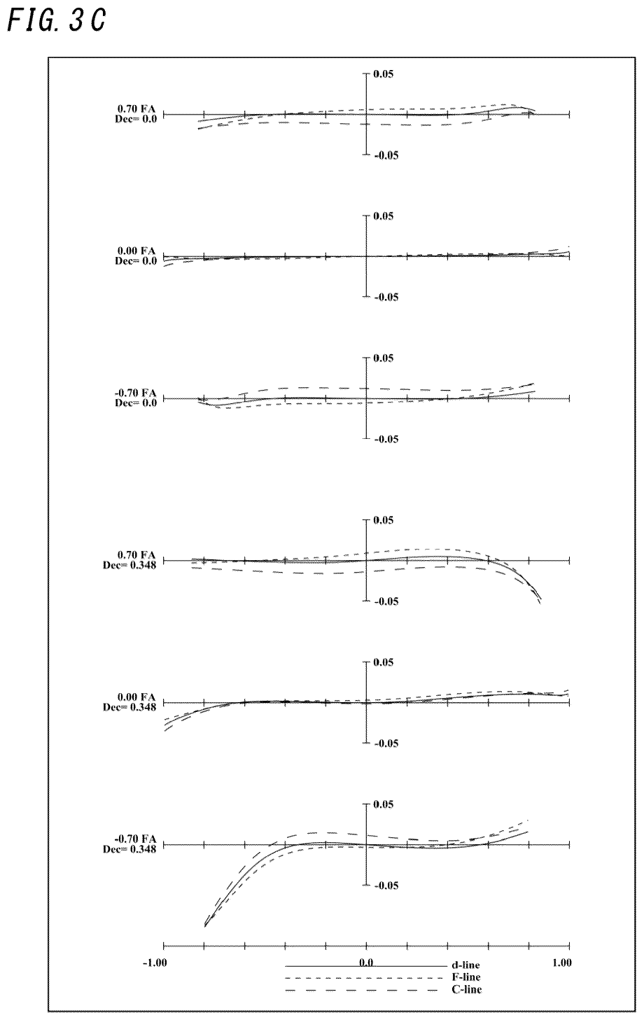

FIG. 3A illustrates an imaging optical system according to a third embodiment.

The imaging optical system includes: a first lens group G1 having positive power; a second lens group G2 having negative power; a third lens group G3 having positive power; a fourth lens group G4 having positive power; a fifth lens group G5 having negative power; and a sixth lens group G6 having negative power. The first, second, third, fourth, fifth, and sixth lens groups G1, G2, G3, G4, G5, G6 are arranged in this order such that the first lens group G1 is located closer to an object than any of the second, third, fourth, fifth, or sixth lens group G2, G3, G4, G5, G6 is and that the sixth lens group G6 is located closer to an image plane than any of the first, second, third, fourth, or fifth lens group G1, G2, G3, G4, G5 is.

The imaging optical system forms an image at a point on the image plane S.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is. The first lens L1 and the second lens L2 are bonded together with an adhesive, for example, to form a bonded lens. That is to say, the bonded lens includes the first lens L1 and the second lens L2. The second lens group G2 is made up of: a fourth lens L4 having negative power; a fifth lens L5 having negative power; a sixth lens L6 having positive power; and a seventh lens L7 having negative power. The fourth, fifth, sixth, and seventh lenses L4, L5, L6, L7 are arranged in this order such that the fourth lens L4 is located closer to the object than any other member of this second lens group G2 is and that the seventh lens L7 is located closer to the image plane than any other member of this second lens group G2 is. The fifth lens L5 and the sixth lens L6 are bonded together with an adhesive, for example, to form a bonded lens. That is to say, the bonded lens includes the fifth lens L5 and the sixth lens L6.

The third lens group G3 is made up of: an aperture stop A; an eighth lens L8 having positive power; a ninth lens L9 having negative power; a tenth lens L10 having positive power; and an eleventh lens L11 having negative power. The aperture stop A and the eighth, ninth, tenth, and eleventh lenses L8, L9, L10, L11 are arranged in this order such that the aperture stop A is located closer to the object than any other member of this third lens group G3 is and that the eleventh lens L11 is located closer to the image plane than any other member of this third lens group G3 is. The ninth lens L9 and the tenth lens L10 are bonded together with an adhesive, for example, to form a bonded lens. That is to say, the bonded lens includes the ninth lens L9 and the tenth lens L10.

The fourth lens group G4 is made up of a twelfth lens L12 having positive power and a thirteenth lens L13 having positive power. The twelfth lens L12 is located closer to the object than the thirteenth lens L13 is. The thirteenth lens L13 is located closer to the image plane than the twelfth lens L12 is.

The fifth lens group G5 is made up of: a fourteenth lens L14 having positive power; and a fifteenth lens L5 having negative power. The fourteenth lens L14 is located closer to the object than the fifteenth lens L15 is. The fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having negative power and a seventeenth lens L17 having positive power. The sixteenth lens L16 is located closer to the object than the seventeenth lens L17 is. The seventeenth lens L17 is located closer to the image plane than the sixteenth lens L16 is.

The respective lenses will be described.

First, the respective lenses that form the first lens group G1 will be described. The first lens L1 is a meniscus lens having a convex surface facing the object. The second lens L2 is a biconvex lens. The third lens L3 is a meniscus lens having a convex surface facing the object.

Next, the respective lenses that form the second lens group G2 will be described. The fourth lens L4 is a meniscus lens having a convex surface facing the object. The fifth lens L5 is a biconcave lens. The sixth lens L6 is a biconvex lens. The seventh lens L7 is a biconcave lens.

Next, the respective lenses that form the third lens group G3 will be described. The eighth lens L8 is a biconvex lens. The ninth lens L9 is a meniscus lens having a convex surface facing the object. The tenth lens L10 is a biconvex lens. The eleventh lens L11 is a meniscus lens having a convex surface facing the image plane. In this case, the eighth lens L8 is an example of the lens LG3F1. The eighth lens L8 is an example of the group of fixed lenses G3Obj configured not to move perpendicularly to the optical axis during image stabilization. The ninth lens L9 is an example of the lens LG3F2. The ninth lens L9 and the tenth lens L10 are an example of a group of image stabilizer lenses that move perpendicularly to the optical axis during the image stabilization. The eleventh lens L11 is an example of the lens LG3R1. The eleventh lens L11 is an example of a group of fixed lenses G3Img that does not move perpendicularly to the optical axis during the image stabilization.

Next, the respective lenses that form the fourth lens group G4 will be described. The twelfth lens L12 is a meniscus lens having a convex surface facing the object. The thirteenth lens L13 is a biconvex lens. The object-side and image-side surfaces of the thirteenth lens L13 are aspheric surfaces. In this case, the twelfth lens L12 is an example of the lens LG4F1. The twelfth lens L12 is an example of the lens LG4Fp1. The thirteenth lens L13 is an example of the lens LG4F2.

Next, the respective lenses that form the fifth lens group G5 will be described. The fourteenth lens L14 is a biconvex lens. The fifteenth lens L15 is a biconcave lens.

Next, the respective lenses that form the sixth lens group G6 will be described. The sixteenth lens L16 is a meniscus lens having a convex surface facing the image plane. The seventeenth lens L17 is a biconvex lens.

While the imaging optical system according to the third embodiment is zooming from the wide-angle end toward the telephoto end during a shooting session, the first lens group G1, the second lens group G2, the third lens group G3, the fourth lens group G4, the fifth lens group G5, and the sixth lens group G6 all move toward the object with respect to the image plane S. In the meantime, as the imaging optical system is zooming, the first, second, third, fourth, fifth, and sixth lens groups G1, G2, G3, G4, G5, G6 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 increases from the wide-angle end through a middle position but decreases from the middle position through the telephoto end, and the interval between the fifth lens group G5 and the sixth lens group G6 increases.

While the imaging optical system according to the third embodiment is focusing to make a transition from the infinity in-focus state toward the close-object in-focus state, the fifth lens group G5 moves along the optical axis toward the image plane.

Meanwhile, the ninth lens L9 and the tenth lens L10 (forming the group of image stabilizer lenses) which belong to the third lens group G3 move perpendicularly to the optical axis to optically compensate for the image blur. These image blur compensation lenses (namely, the ninth lens L9 and the tenth lens L10) allow the imaging optical system to compensate for the shift of the image point due to the vibration of the overall system. That is to say, this allows the imaging optical system to optically compensate for the image blur due to camera shake, vibrations, and other disturbances.

### Fourth Embodiment

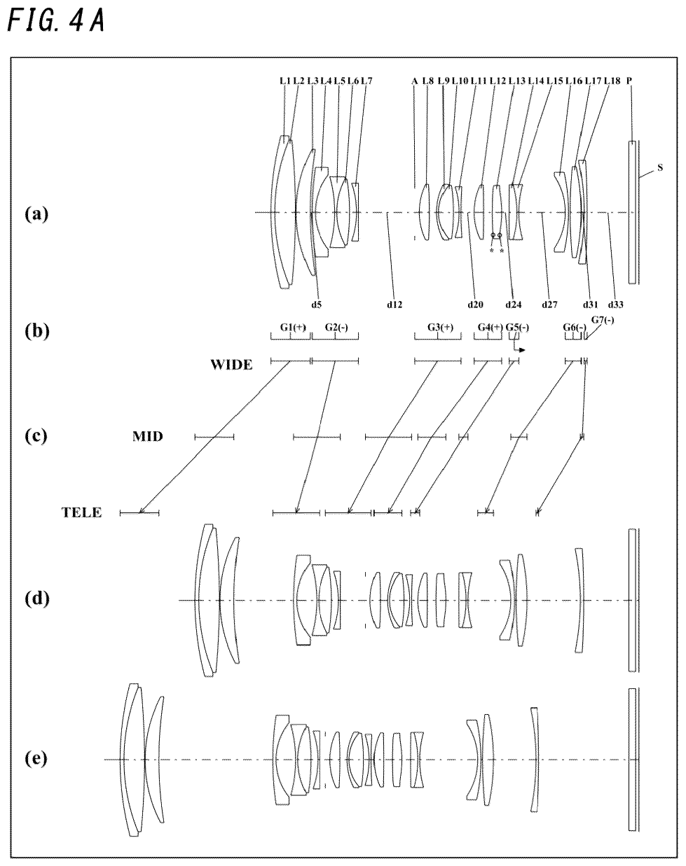

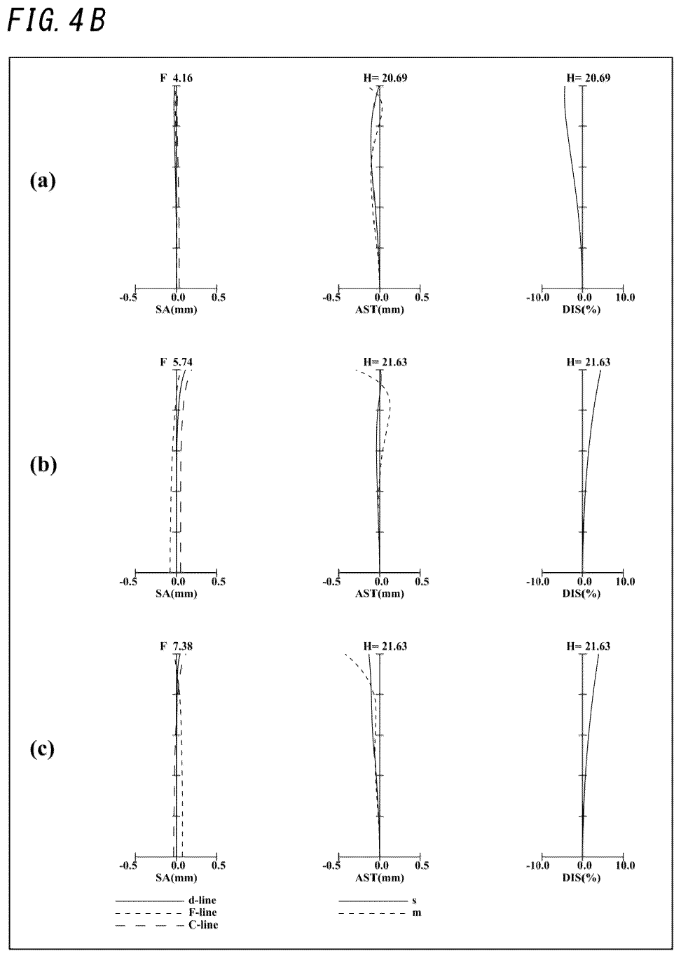

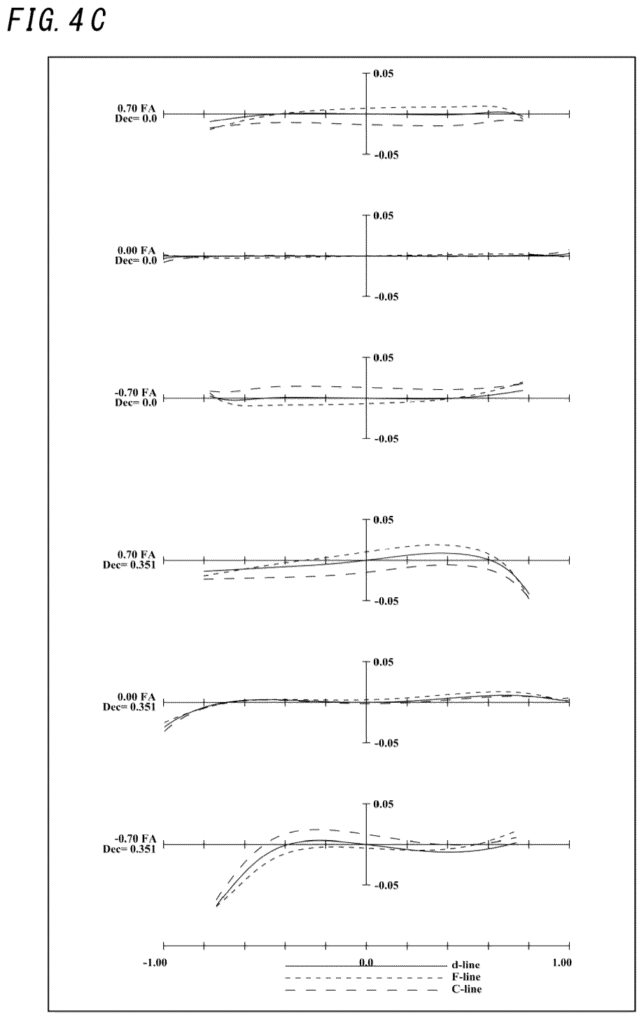

FIG. 4A illustrates an imaging optical system according to a fourth embodiment.

The imaging optical system includes: a first lens group G1 having positive power; a second lens group G2 having negative power; a third lens group G3 having positive power; a fourth lens group G4 having positive power; a fifth lens group G5 having negative power; a sixth lens group G6 having negative power; and a seventh lens group G7 having negative power. The first, second, third, fourth, fifth, sixth, and seventh lens groups G1, G2, G3, G4, G5, G6, G7 are arranged in this order such that the first lens group G1 is located closer to an object than any of the second, third, fourth, fifth, sixth, or seventh lens group G2, G3, G4, G5, G6, G7 is and that the seventh lens group G7 is located closer to an image plane than any of the first, second, third, fourth, fifth, or sixth lens group G1, G2, G3, G4, G5, G6 is.

The imaging optical system forms an image at a point on the image plane S.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is. The first lens L1 and the second lens L2 are bonded together with an adhesive, for example, to form a bonded lens. That is to say, the bonded lens includes the first lens L1 and the second lens L2.

The second lens group G2 is made up of: a fourth lens L4 having negative power; a fifth lens L5 having negative power; a sixth lens L6 having positive power; and a seventh lens L7 having negative power. The fourth, fifth, sixth, and seventh lenses L4, L5, L6, L7 are arranged in this order such that the fourth lens L4 is located closer to the object than any other member of this second lens group G2 is and that the seventh lens L7 is located closer to the image plane than any other member of this second lens group G2 is. The fifth lens L5 and the sixth lens L6 are bonded together with an adhesive, for example, to form a bonded lens. That is to say, the bonded lens includes the fifth lens L5 and the sixth lens L6.

The third lens group G3 is made up of: an aperture stop A; an eighth lens L8 having positive power; a ninth lens L9 having negative power; a tenth lens L10 having positive power; and an eleventh lens L11 having negative power. The aperture stop A and the eighth, ninth, tenth, and eleventh lenses L8, L9, L10, L11 are arranged in this order such that the aperture stop A is located closer to the object than any other member of this third lens group G3 is and that the eleventh lens L11 is located closer to the image plane than any other member of this third lens group G3 is. The ninth lens L9 and the tenth lens L10 are bonded together with an adhesive, for example, to form a bonded lens. That is to say, the bonded lens includes the ninth lens L9 and the tenth lens L10.

The fourth lens group G4 is made up of a twelfth lens L12 having positive power and a thirteenth lens L13 having positive power. The twelfth lens L12 is located closer to the object than the thirteenth lens L13 is. The thirteenth lens L13 is located closer to the image plane than the twelfth lens L12 is.

The fifth lens group G5 is made up of: a fourteenth lens L14 having positive power; and a fifteenth lens L5 having negative power. The fourteenth lens L14 is located closer to the object than the fifteenth lens L15 is. The fifteenth lens L15 is located closer to the image plane than the fourteenth lens L14 is. The fourteenth lens L14 and the fifteenth lens L15 are bonded together with an adhesive, for example, to form a bonded lens. That is to say, the bonded lens includes the fourteenth lens L14 and the fifteenth lens L15.

The sixth lens group G6 is made up of a sixteenth lens L16 having negative power and a seventeenth lens L17 having positive power. The sixteenth lens L16 is located closer to the object than the seventeenth lens L17 is. The seventeenth lens L17 is located closer to the image plane than the sixteenth lens L16 is.

The seventh lens group G7 consists of an eighteenth lens L18 having negative power.

The respective lenses will be described.

First, the respective lenses that form the first lens group G1 will be described. The first lens L1 is a meniscus lens having a convex surface facing the object. The second lens L2 is a biconvex lens. The third lens L3 is a meniscus lens having a convex surface facing the object.

Next, the respective lenses that form the second lens group G2 will be described. The fourth lens L4 is a meniscus lens having a convex surface facing the object. The fifth lens L5 is a biconcave lens. The sixth lens L6 is a biconvex lens. The seventh lens L7 is a biconcave lens.

Next, the respective lenses that form the third lens group G3 will be described. The eighth lens L8 is a biconvex lens. The ninth lens L9 is a meniscus lens having a convex surface facing the object. The tenth lens L10 is a biconvex lens. The eleventh lens L11 is a biconcave lens. In this case, the eighth lens L8 is an example of the lens LG3F1. The eighth lens L8 is an example of the group of fixed lenses G3Obj configured not to move perpendicularly to the optical axis during image stabilization. The ninth lens L9 is an example of the lens LG3F2. The ninth lens L9 and the tenth lens L10 are an example of a group of image stabilizer lenses that move perpendicularly to the optical axis during the image stabilization. The eleventh lens L11 is an example of the lens LG3R1. The eleventh lens L11 is an example of a group of fixed lenses G3Img that does not move perpendicularly to the optical axis during the image stabilization.

Next, the respective lenses that form the fourth lens group G4 will be described. The twelfth lens L12 is a biconvex lens. The thirteenth lens L13 is a biconvex lens. The object-side and image-side surfaces of the thirteenth lens L13 are aspheric surfaces. In this case, the twelfth lens L12 is an example of the lens LG4F1. The twelfth lens L12 is an example of the lens LG4Fp1. The thirteenth lens L13 is an example of the lens LG4F2.

Next, the respective lenses that form the fifth lens group G5 will be described. The fourteenth lens L14 is a biconvex lens. The fifteenth lens L15 is a biconcave lens.

Next, the respective lenses that form the sixth lens group G6 will be described. The sixteenth lens L16 is a meniscus lens having a convex surface facing the image plane. The seventeenth lens L17 is a biconvex lens.

Next, the lens that forms the seventh lens group G7 will be described. The eighteenth lens L18 is a meniscus lens having a convex surface facing the image plane.

While the imaging optical system according to the fourth embodiment is zooming from the wide-angle end toward the telephoto end during a shooting session, the first lens group G1, the second lens group G2, the third lens group G3, the fourth lens group G4, the fifth lens group G5, the sixth lens group G6, and the seventh lens group G7 all move toward the object with respect to the image plane S. In the meantime, as the imaging optical system is zooming, the first, second, third, fourth, fifth, sixth, and seventh lens groups G1, G2, G3, G4, G5, G6, G7 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 increases from the wide-angle end through a middle position but decreases from the middle position through the telephoto end, the interval between the fifth lens group G5 and the sixth lens group G6 decreases from the wide-angle end through the middle position but increases from the middle position through the telephoto end, and the interval between the sixth lens group G6 and the seventh lens group G7 increases from the wide-angle end through the middle position but decreases from the middle position through the telephoto end.

While the imaging optical system according to the fourth embodiment is focusing to make a transition from the infinity in-focus state toward the close-object in-focus state, the fifth lens group G5 moves along the optical axis toward the image plane.

Meanwhile, the ninth lens L9 and the tenth lens L10 (forming the group of image stabilizer lenses) which belong to the third lens group G3 move perpendicularly to the optical axis to optically compensate for the image blur. These image blur compensation lenses (namely, the ninth lens L9 and the tenth lens L10) allow the imaging optical system to compensate for the shift of the image point due to the vibration of the overall system. That is to say, this allows the imaging optical system to optically compensate for the image blur due to camera shake, vibrations, and other disturbances.

### Fifth Embodiment

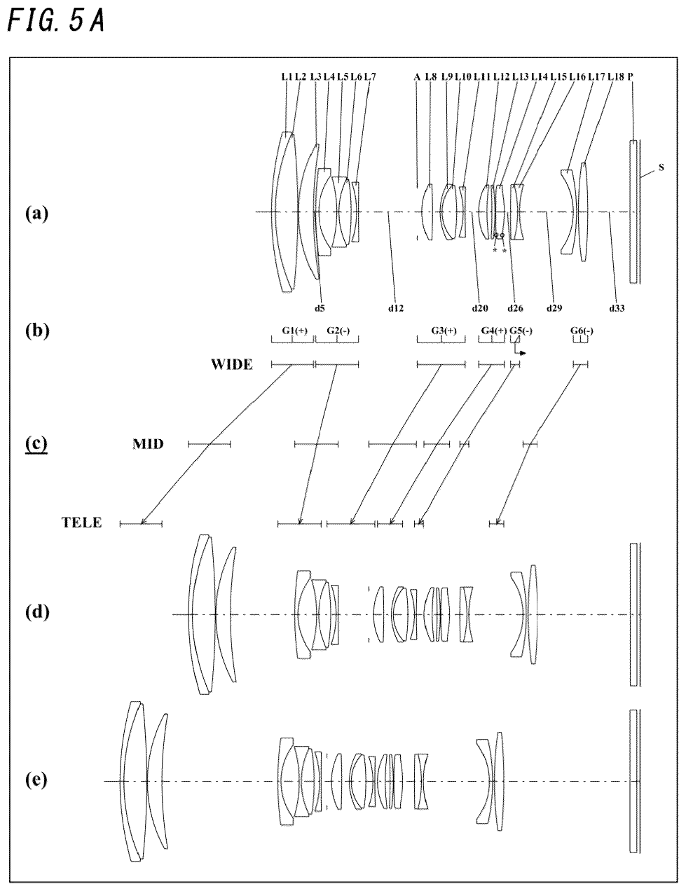

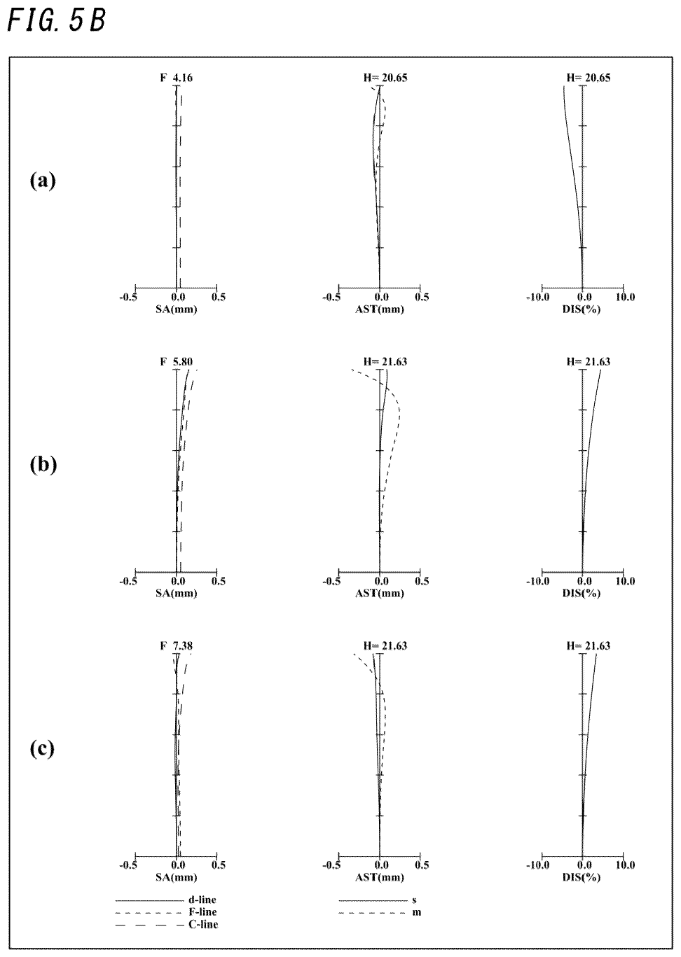

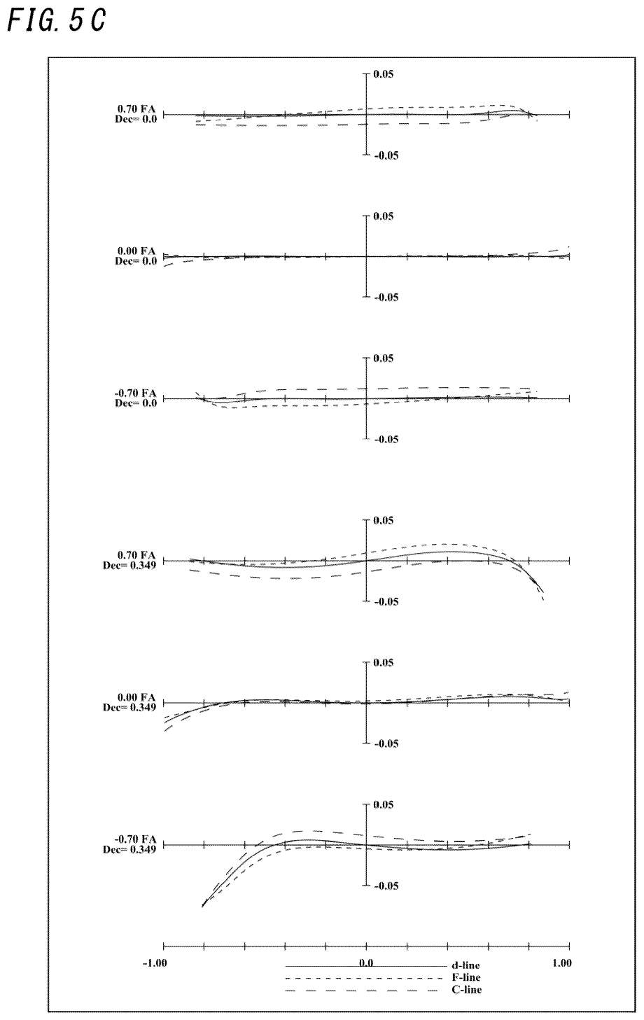

FIG. 5A illustrates an imaging optical system according to a fifth embodiment.

The imaging optical system includes: a first lens group G1 having positive power; a second lens group G2 having negative power; a third lens group G3 having positive power; a fourth lens group G4 having positive power; a fifth lens group G5 having negative power; and a sixth lens group G6 having negative power. The first, second, third, fourth, fifth, and sixth lens groups G1, G2, G3, G4, G5, G6 are arranged in this order such that the first lens group G1 is located closer to an object than any of the second, third, fourth, fifth, or sixth lens group G2, G3, G4, G5, G6 is and that the sixth lens group G6 is located closer to an image plane than any of the first, second, third, fourth, or fifth lens group G1, G2, G3, G4, G5 is.

The imaging optical system forms an image at a point on the image plane S.

The first lens group G1 is made up of: a first lens L1 having negative power; a second lens L2 having positive power; and a third lens L3 having positive power. The first lens L1, the second lens L2, and the third lens L3 are arranged in this order such that the first lens L1 is located closer to the object than any other member of this first lens group G1 is and that the third lens L3 is located closer to the image plane than any other member of this first lens group G1 is. The first lens L1 and the second lens L2 are bonded together with an adhesive, for example, to form a bonded lens. That is to say, the bonded lens includes the first lens L1 and the second lens L2.

The second lens group G2 is made up of: a fourth lens L4 having negative power; a fifth lens L5 having negative power; a sixth lens L6 having positive power; and a seventh lens L7 having negative power. The fourth, fifth, sixth, and seventh lenses L4, L5, L6, L7 are arranged in this order such that the fourth lens L4 is located closer to the object than any other member of this second lens group G2 is and that the seventh lens L7 is located closer to the image plane than any other member of this second lens group G2 is. The fifth lens L5 and the sixth lens L6 are bonded together with an adhesive, for example, to form a bonded lens. That is to say, the bonded lens includes the fifth lens L5 and the sixth lens L6.

The third lens group G3 is made up of: an aperture stop A; an eighth lens L8 having positive power; a ninth lens L9 having negative power; a tenth lens L10 having positive power; and an eleventh lens L11 having negative power. The aperture stop A and the eighth, ninth, tenth, and eleventh lenses L8, L9, L10, L11 are arranged in this order such that the aperture stop A is located closer to the object than any other member of this third lens group G3 is and that the eleventh lens L11 is located closer to the image plane than any other member of this third lens group G3 is. The ninth lens L9 and the tenth lens L10 are bonded together with an adhesive, for example, to form a bonded lens. That is to say, the bonded lens includes the ninth lens L9 and the tenth lens L10.

The fourth lens group G4 is made up of a twelfth lens L12 having positive power, a thirteenth lens L13 having positive power, and a fourteenth lens L14 having positive power. The twelfth lens L12 is located closer to the object than the thirteenth lens L13 or the fourteenth lens L14 is. The fourteenth lens L14 is located closer to the image plane than the twelfth lens L12 or the thirteenth lens L13 is.

The fifth lens group G5 is made up of: a fifteenth lens L15 having positive power; and a sixteenth lens L16 having negative power. The fifteenth lens L15 is located closer to the object than the sixteenth lens L16 is. The sixteenth lens L16 is located closer to the image plane than the fifteenth lens L15 is. The fifteenth lens L15 and the sixteenth lens L16 are bonded together with an adhesive, for example, to form a bonded lens. That is to say, the bonded lens includes the fifteenth lens L15 and the sixteenth lens L16.

The sixth lens group G6 is made up of a seventeenth lens L17 having negative power and an eighteenth lens L18 having positive power. The seventeenth lens L17 is located closer to the object than the eighteenth lens L18 is. The eighteenth lens L18 is located closer to the image plane than the seventeenth lens L17 is.

The respective lenses will be described.

First, the respective lenses that form the first lens group G1 will be described. The first lens L1 is a meniscus lens having a convex surface facing the object. The second lens L2 is a biconvex lens. The third lens L3 is a meniscus lens having a convex surface facing the object.

Next, the respective lenses that form the second lens group G2 will be described. The fourth lens L4 is a meniscus lens having a convex surface facing the object. The fifth lens L5 is a biconcave lens. The sixth lens L6 is a biconvex lens. The seventh lens L7 is a biconcave lens.

Next, the respective lenses that form the third lens group G3 will be described. The eighth lens L8 is a biconvex lens. The ninth lens L9 is a meniscus lens having a convex surface facing the object. The tenth lens L10 is a biconvex lens. The eleventh lens L11 is a biconcave lens. In this case, the eighth lens L8 is an example of the lens LG3F1. The eighth lens L8 is an example of the group of fixed lenses G3Obj configured not to move perpendicularly to the optical axis during image stabilization. The ninth lens L9 is an example of the lens LG3F2. The ninth lens L9 and the tenth lens L10 are an example of a group of image stabilizer lenses that move perpendicularly to the optical axis during the image stabilization. The eleventh lens L11 is an example of the lens LG3R1. The eleventh lens L11 is an example of a group of fixed lenses G3Img that does not move perpendicularly to the optical axis during the image stabilization.

Next, the respective lenses that form the fourth lens group G4 will be described. The twelfth lens L12 is a meniscus lens having a convex surface facing the object. The thirteenth lens L13 is a meniscus lens having a convex surface facing the image plane. The fourteenth lens L14 is a biconvex lens. The object-side and image-side surfaces of the fourteenth lens L14 are aspheric surfaces. In this case, the twelfth lens L12 is an example of the lens LG4F1. The twelfth lens L12 is an example of the lens LG4Fp1. The thirteenth lens L13 is an example of the lens LG4F2.

Next, the respective lenses that form the fifth lens group G5 will be described. The fifteenth lens L15 is a biconvex lens. The sixteenth lens L16 is a biconcave lens.

Next, the respective lenses that form the sixth lens group G6 will be described. The seventeenth lens L17 is a meniscus lens having a convex surface facing the image plane. The eighteenth lens L18 is a biconvex lens.

While the imaging optical system according to the fifth embodiment is zooming from the wide-angle end toward the telephoto end during a shooting session, the first lens group G1, the second lens group G2, the third lens group G3, the fourth lens group G4, the fifth lens group G5, and the sixth lens group G6 all move toward the object with respect to the image plane S. In the meantime, as the imaging optical system is zooming, the first, second, third, fourth, fifth, and sixth lens groups G1, G2, G3, G4, G5, G6 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 increases, and the interval between the fifth lens group G5 and the sixth lens group G6 increases.

While the imaging optical system according to the fifth embodiment is focusing to make a transition from the infinity in-focus state toward the close-object in-focus state, the fifth lens group G5 moves along the optical axis toward the image plane.

Meanwhile, the ninth lens L9 and the tenth lens L10 (forming the group of image stabilizer lenses) which belong to the third lens group G3 move perpendicularly to the optical axis to optically compensate for the image blur. These image blur compensation lenses (namely, the ninth lens L9 and the tenth lens L10) allow the imaging optical system to compensate for the shift of the image point due to the vibration of the overall system. That is to say, this allows the imaging optical system to optically compensate for the image blur due to camera shake, vibrations, and other disturbances.

### Other Embodiments

The first, second, third, fourth, and fifth embodiments have been described as exemplary embodiments of the present disclosure. Note that the embodiments described above are only examples of the present disclosure and should not be construed as limiting. Rather, each of these embodiments may be readily modified, replaced, combined with other embodiments, provided with some additional components, or partially omitted without departing from the scope of the present disclosure.

For example, in the first to fifth embodiments described above, the imaging optical system is supposed to be used in the entire zoom range from the wide-angle end through the telephoto end. However, the imaging optical system does not have to be used in the entire zoom range. Alternatively, the imaging optical system may also be used selectively only in an extracted range where optical performance is ensured according to the desired zoom range, for example. That is to say, the imaging optical system may also be used as an imaging optical system with lower zoom power than the imaging optical system to be described for the first, second, third, fourth, and fifth examples of numerical values corresponding to the first, second, third, fourth, and fifth embodiments, respectively. Optionally, the imaging optical system may also be used selectively as a single-focus lens system only at an extracted focal length where optical performance is ensured according to the desired zoom position.

In addition, the number of the lens groups and the number of the lenses that form each lens group are substantial numbers. Optionally, a lens having substantially no power may be added to any of the lens groups described above.

In the embodiments described above, the image blur is compensated for by moving the image blur compensation lenses perpendicularly to the optical axis. However, the image blur may be compensated for as long as the lenses are moved such that each of those lenses has a vertical direction component. For example, the image blur may also be compensated for by pivoting the image blur compensation lenses around a center of rotation on the optical axis (i.e., with the lenses tilted such that the axis of each of these lenses intersects with the optical axis of the imaging optical system) if the lens barrel is allowed to have a complicated structure.

### (Conditions and Advantages)

Next, conditions that may be satisfied by the imaging optical systems according to the first to fifth embodiments, for example, will be described. A plurality of possible conditions may be defined for the imaging optical system according to each of the first to fifth embodiments. In that case, an imaging optical system, of which the configuration satisfies all of these possible conditions, is most advantageous. Alternatively, an imaging optical system that achieves its expected advantages by satisfying any of the individual conditions to be described below may also be provided.

An imaging optical system according to each of the first to fifth embodiments described above includes: a first lens group having positive power; a second lens group having negative power; a third lens group having positive power; a fourth lens group having positive power; a fifth lens group having negative power; and a sixth lens group having power. The first, second, third, fourth, fifth, and sixth lens groups are arranged in this order such that the first lens group is located closer to an object than any of the second, third, fourth, fifth or sixth lens group is, and that the sixth lens group is located closer to an image plane than any of the first, second, third, fourth, or fifth lens group is. An interval between each pair of lens groups that are adjacent to each other changes as at least the first, second, third, fourth, fifth, and sixth lens groups move in an optical axis direction while the imaging optical system is zooming. The optical axis direction is a direction aligned with an optical axis of the imaging optical system. This configuration will be hereinafter referred to as a “basic configuration.”

The imaging optical system with the basic configuration has a configuration that may be used effectively to reduce the overall size of the zoom lens. This allows the imaging optical system to compensate for various types of aberrations that occur to the respective lens groups during zooming. Consequently, this allows for providing an imaging optical system having the ability to compensate for various types of aberrations sufficiently over the entire zoom range.

For example, in the imaging optical system, the third lens group G3 preferably includes: a group of image stabilizer lenses consisting of a plurality of lenses configured to move perpendicularly to the optical axis during an image stabilization; and a group of fixed lenses G3Obj located closer to the object than the group of image stabilizer lenses is, consisting of one or more lenses, and configured not to move perpendicularly to the optical axis during the image stabilization.

The imaging optical system preferably satisfies the following inequality (1):

$$0.06 < Th\_IS \_Obj / Th\_G3 < 0.50 \qquad ( 1 )$$

where Th_IS_Obj is an air gap on the optical axis between the group of image stabilizer lenses and the group of fixed lenses G3Obj, and
Th_G3 is the thickness of the third lens group G3 on the optical axis.

The condition expressed by this inequality (1) defines the ratio of an air gap on the optical axis between the group of image stabilizer lenses and the group of fixed lenses G3Obj to the thickness of the third lens group G3 on the optical axis (i.e., a thickness measured on the optical axis from the object-side surface of a lens located closer to the object than any other lens belonging to the third lens group G3 is to the image-side surface of a lens located closer to the image plane than any other lens belonging to the third lens group G3 is).

If the Th_IS_Obj/Th_G3 ratio were less than the lower limit set by the inequality (1), then the spherical aberration would be too positively biased (i.e., toward the positive side of the spherical aberration diagram to be referred to later) over the entire zoom range and the image plane would be too negatively biased (i.e., toward the negative side of the spherical aberration diagram to be referred to later) over the entire zoom range, which is not beneficial.

Conversely, if the Th_IS_Obj/Th_G3 ratio were greater than the upper limit set by the inequality (1), then the spherical aberration would be too negatively biased over the entire zoom range and the image plane would be too positively biased over the entire zoom range, which is not beneficial, either.

To enhance the advantage described above, the condition(s) expressed by one or both of the following inequalities (1a) and (1b) is/are preferably satisfied:

$$0.08 < Th\_IS \_Obj / Th\_G3 \qquad ( 1 a )$$

$$Th\_IS \_Obj / Th\_G3 < 0 \text{.30} . \qquad ( 1 b )$$

More preferably, to further enhance the advantage described above, the condition(s) expressed by one or both of the following inequalities (1c) and (1d) is/are satisfied:

$$0.1 < Th\_IS \_Obj / Th\_G3 \qquad ( 1 c )$$

$$Th\_IS \_Obj / Th\_G3 < 0 \text{.25} . \qquad ( 1 d )$$

Even more preferably, to further enhance the advantage described above, the condition(s) expressed by one or both of the following inequalities (1) and (1f) is/are satisfied:

$$0. 12 < Th\_IS \_Obj / Th\_G3 \qquad ( 1 e )$$

$$Th\_IS \_Obj / Th\_G3 < 0.2 . \qquad ( 1 f )$$

For example, in the imaging optical system, the fourth lens group G4 preferably includes at least two lenses.

The imaging optical system preferably satisfies the following inequality (2):

$$0.05 < Th\_G4 \_Air / Th\_G4 < 0.80 \qquad ( 2 )$$

where Th_G4 Air is a maximum value of an air gap on the optical axis between adjacent lenses included in at least two lenses that form the fourth lens group G4; and
Th_G4 is the thickness of the fourth lens group G4 on the optical axis.

The condition expressed by the inequality (2) defines the ratio of a maximum value of an air gap between adjacent lenses included in at least two lenses which form part of the fourth lens group G4 to the thickness of the fourth lens group G4 on the optical axis.

If the Th_G4_Air/Th_G4 ratio were less than the lower limit set by the inequality (2), then the spherical aberration would be too positively biased (i.e., toward the positive side of the spherical aberration diagram to be referred to later) on the telephoto side and the image plane would be too negatively biased (i.e., toward the negative side of the spherical aberration diagram to be referred to later) on the telephoto side, which is not beneficial.

Conversely, if the Th_G4_Air/Th_G4 ratio were greater than the upper limit set by the inequality (2), then the spherical aberration would be too negatively biased on the telephoto side and the image plane would be too positively biased on the telephoto side, which is not beneficial, either.

To enhance the advantage described above, the condition(s) expressed by one or both of the following inequalities (2a) and (2b) is/are preferably satisfied:

$$0.075 < Th\_G4 \_Air / Th\_G4 \qquad ( 2 a )$$

$$Th\_G4 \_Air / Th\_G4 < 0.7 0. \qquad ( 2 b )$$

More preferably, to further enhance the advantage described above, the condition(s) expressed by one or both of the following inequalities (2c) and (2d) is/are satisfied:

$$0.1 \; 00 < Th\_G4 \_Air / Th\_G4 \qquad ( 2 c )$$

$$Th\_G4 \_Air / Th\_G4 < 0.6 0. \qquad ( 2 d )$$

Even more preferably, to further enhance the advantage described above, the condition(s) expressed by one or both of the following inequalities (2e) and (2f) is/are satisfied:

$$0.1 \; 50 < Th\_G4 \_Air / Th\_G4 \qquad ( 2 e )$$

$$Th\_G4 \_Air / Th\_G4 < 0.5 0. \qquad ( 2 f )$$

Particularly preferably, to further enhance the advantage described above, the condition(s) expressed by one or both of the following inequalities (2g) and (2h) is/are satisfied:

$$0.1 \; 90 < Th\_G4 \_Air / Th\_G4 \qquad ( 2 g )$$

$$Th\_G4 \_Air / Th\_G4 < 0.4 0. \qquad ( 2 h )$$

For example, in the imaging optical system, the third lens group G3 preferably includes: a group of image stabilizer lenses consisting of a plurality of lenses configured to move perpendicularly to the optical axis during an image stabilization; a group of fixed lenses G3Obj located closer to the object than the group of image stabilizer lenses is, consisting of one or more lenses, and configured not to move perpendicularly to the optical axis during an image stabilization; and a group of fixed lenses G3Img located closer to the image plane than the group of image stabilizer lenses is, consisting of one or more lenses, and configured not to move perpendicularly to the optical axis during the image stabilization.

This may reduce the chances of the group of image stabilizer lenses moving during the image stabilization. Consequently, the aberrations may be compensated for sufficiently even when the group of image stabilizer lenses moves perpendicularly to the optical axis.

For example, in the imaging optical system, an object-side surface of a lens LG3R1 located closer to the image plane than any of other negative lenses that form part of the third lens group G3 preferably has a convex surface facing the image plane.

This allows the spherical aberration occurring in the third lens group G3 having positive power to be compensated for sufficiently over the entire zoom range.

For example, in the imaging optical system, the third lens group G3 preferably includes: a group of image stabilizer lenses consisting of a plurality of lenses configured to move perpendicularly to the optical axis during an image stabilization; and a group of fixed lenses G3Img located closer to the image plane than the group of image stabilizer lenses is, consisting of one or more lenses, and configured not to move perpendicularly to the optical axis.

The imaging optical system preferably satisfies the following inequality (3):

$$0.05 < Th\_IS \_Img / Th\_G3 < 0.80 \qquad ( 3 )$$

where Th_IS_Img is an air gap on the optical axis between the group of image stabilizer lenses and the group of fixed lenses G3Img, and
Th G3 is the thickness of the third lens group G3 on the optical axis.

The condition expressed by the inequality (3) defines the ratio of an air gap on the optical axis between the group of image stabilizer lenses and the group of fixed lenses G3Img to the thickness of the third lens group G3 on the optical axis (i.e., a thickness measured on the optical axis from the object-side surface of a lens located closer to the object than any other lens belonging to the third lens group G3 is to the image-side surface of a lens located closer to the image plane than any other lens belonging to the third lens group G3 is).

If the Th_IS_Img/Th_G3 ratio were less than the lower limit set by the inequality (3), then the spherical aberration would be too positively biased (i.e., toward the positive side of the spherical aberration diagram to be referred to later) over the entire zoom range, which is not beneficial.

Conversely, if the Th_IS_Img/Th_G3 ratio were greater than the upper limit set by the inequality (3), then the spherical aberration would be too negatively biased (i.e., toward the negative side of the spherical aberration diagram to be referred to later) over the entire zoom range, which is not beneficial, either.

To enhance the advantage described above, the condition(s) expressed by one or both of the following inequalities (3a) and (3b) is/are preferably satisfied:

$$0.075 < Th\_IS \_Img / Th\_G3 \qquad ( 3 a )$$

$$Th\_IS \_Img / Th\_G3 < 0.4 . \qquad ( 3 b )$$

More preferably, to further enhance the advantage described above, the condition(s) expressed by one or both of the following inequalities (3c) and (3d) is/are satisfied:

$$0.12 < Th\_IS \_Img / Th\_G3 \qquad ( 3 c )$$

$$Th\_IS \_Img / Th\_G3 < 0.2 . \qquad ( 3 d )$$

For example, the imaging optical system preferably satisfies the following inequality (4):

$$0. < ( R2\_LG3F1 + R1\_LG3F2 ) / ( R2\_LG3F1 - R1\_LG3F2 ) < 1. \qquad ( 4 )$$

where R2_LG3F1 is a radius of curvature of an image-side surface of a lens LG3F1 located closer to the object than any other lens belonging to the third lens group G3 is, and
R1_LG3F2 is a radius of curvature of an object-side surface of a lens LG3F2 located adjacent to the lens LG3F1 and closer to the image plane than the lens LG3F1 is.

The condition expressed by the inequality (4) defines the ratio of the sum of a radius of curvature of an image-side surface of a lens LG3F1 located closer to the object than any other lens belonging to the third lens group and a radius of curvature of an object-side surface of a lens LG3F2 located adjacent to the lens LG3F1 and closer to the image plane than the lens LG3F1 is to the difference between the former and latter radii of curvature.

If the ratio were less than the lower limit set by the inequality (4), then the spherical aberration would be too positively biased (i.e., toward the positive side of the spherical aberration diagram to be referred to later) on the telephoto side, which is not beneficial. In addition, the image plane would be too positively biased (i.e., toward the positive side of the spherical aberration diagram to be referred to later) over the entire zoom range, which is not beneficial, either.

Conversely, if the ratio were greater than the upper limit set by the inequality (4), then the spherical aberration would be too negatively biased (i.e., toward the negative side of the spherical aberration diagram to be referred to later) on the telephoto side, which is not beneficial. In addition, the image plane would be too negatively biased (i.e., toward the negative side of the spherical aberration diagram to be referred to later) over the entire zoom range, which is not beneficial, either.

To enhance the advantage described above, the condition(s) expressed by one or both of the following inequalities (4a) and (4b) is/are preferably satisfied:

$$( R2\_LG3F1 + R1\_LG3F2 ) / ( R2\_LG3F1 - R1\_LG3F2 ) < 0 \text{.97} \qquad ( 4 a )$$

$$0. 65 < ( R2\_LG3F1 + R1\_LG3F2 ) / ( R2\_LG3F1 - R1\_LG3F2 ) . \qquad ( 4 b )$$

More preferably, to further enhance the advantage described above, the condition(s) expressed by one or both of the following inequalities (4c) and (4d) is/are satisfied:

$$( R2\_LG3F1 + R1\_LG3F2 ) / ( R2\_LG3F1 - R1\_LG3F2 ) < 0 \text{.95} \qquad ( 4 c )$$

$$0.8 < ( R2\_LG3F1 + R1\_LG3F2 ) / ( R2\_LG3F1 - R1\_LG3F2 ) . \qquad ( 4 d )$$

For example, in the imaging optical system, an image-side surface of a positive lens LG4Fp1 located closer to the object than any other lens belonging to the fourth lens group G4 is preferably has a convex surface facing the object.

This allows the planarity of the image plane S to be corrected sufficiently over the entire zoom range.

For example, the imaging optical system preferably satisfies the following inequality (5):

$$- 10.0 < ( R2\_LG4F1 + R1\_LG4F2 ) / ( R2\_LG4F1 - R1\_LG4F2 ) < 1. \qquad ( 5 )$$

where R2_LG4F1 is a radius of curvature of an image-side surface of a lens LG4F1 located closer to the object than any other lens belonging to the fourth lens group G4 is, and
R1_LG4F2 is a radius of curvature of an object-side surface of a lens LG4F2 located adjacent to the lens LG4F1 and closer to the image plane than the lens LG4F1 is.

The condition expressed by the inequality (5) defines the ratio of the sum of a radius of curvature of an image-side surface of a lens LG4F1 located closer to the object than any other lens belonging to the fourth lens group G4 is and a radius of curvature of an object-side surface of a lens LG4F2 located adjacent to the lens LG4F1 and closer to the image plane than the lens LG4F1 is to the difference between the former and latter radii of curvature.

If the ratio were less than the lower limit set by the inequality (5), then the image plane would be too negatively biased (i.e., toward the negative side of the astigmatism diagram to be referred to later) over the entire zoom range, which is not beneficial.

Conversely, if the ratio were greater than the upper limit set by the inequality (5), then the image plane would be too positively biased (i.e., toward the positive side of the astigmatism diagram to be referred to later) over the entire zoom range, which is not beneficial, either.

To enhance the advantage described above, the condition(s) expressed by one or both of the following inequalities (5a) and (5b) is/are preferably satisfied:

$$( R2\_LG4F1 + R1\_LG4F2 ) / ( R2\_LG4F1 - R1\_LG4F2 ) < 0 \text{.75} \qquad ( 5 a )$$

$$- 8. < ( R2\_LG4F1 + R1\_LG4F2 ) / ( R2\_LG4F1 - R1\_LG4F2 ) . \qquad ( 5 b )$$

More preferably, to further enhance the advantage described above, the condition(s) expressed by one or both of the following inequalities (5c) and (5d) is/are satisfied:

$$( R2\_LG4F1 + R1\_LG4F2 ) / ( R2\_LG4F1 - R1\_LG4F2 ) < 0 \text{.50} \qquad ( 5 c )$$

$$- 6. < ( R2\_LG4F1 + R1\_LG4F2 ) / ( R2\_LG4F1 - R1\_LG4F2 ) . \qquad ( 5 d )$$

For example, the imaging optical system preferably satisfies the following inequality (6):

$$nd\_LG4Fp1 < 1.6 \qquad ( 6 )$$

where nd_LG4Fp1 is a refractive index of a positive lens LG4Fp1 located closer to the object than any other lens belonging to the fourth lens group G4 is.

The condition expressed by the inequality (6) defines the refractive index of a positive lens LG4Fp1 located closer to the object than any other lens belonging to the fourth lens group G4 is.

If the refractive index were greater than the upper limit set by the inequality (6), then the spherical aberration would be too positively biased (i.e., toward the positive side of the astigmatism diagram to be referred to later) over the entire zoom range, which is not beneficial.

To enhance the advantage described above, the condition expressed by the following inequality (6a) is preferably satisfied:

$$nd\_LG4Fp1 < 1.55 . \qquad ( 6 a )$$

More preferably, to further enhance the advantage described above, the imaging optical system satisfies the condition expressed by the following inequality (6b):

$$1.4 < nd\_LG4Fp1 . \qquad ( 6 b )$$

If the refractive index were less than the lower limit set by the inequality (6b), then the spherical aberration might be too negatively biased (i.e., toward the negative side of the astigmatism diagram to be referred to later).

For example, in the imaging optical system, the fifth lens group G5 is preferably configured to move toward the image plane while the imaging optical system is focusing from an infinity in-focus object toward a close-object in-focus state.

This ensures good focus performance while the imaging optical system is focusing.

For example, the imaging optical system preferably satisfies the following inequality (7):

$$0.1 < ThwG5\_G6 / fw < 0.8 \qquad ( 7 )$$

where ThwG5_G6 is an interval measured on the optical axis between the fifth lens group G5 and the sixth lens group G6 in the imaging optical system at a wide-angle end; and
fw is a focal length of the imaging optical system at the wide-angle end.

The condition expressed by the inequality (7) defines the ratio of an interval measured on the optical axis between the fifth lens group G5 and the sixth lens group G6 in the imaging optical system at a wide-angle end to a focal length of the imaging optical system at the wide-angle end.

If the ThwG5_G6/fw ratio were less than the lower limit set by the inequality (7), the magnitude of movement of the fifth lens group G5 toward the image plane while the imaging optical system is focusing from the infinity in-focus state toward the close-object in-focus state would decrease to the point of causing a decline in focusing accuracy, which is not beneficial.

Conversely, if the ThwG5_G6/fw ratio were greater than the upper limit set by the inequality (7), the magnitude of movement of the fifth lens group G5 toward the image plane while the imaging optical system is focusing from the infinity in-focus state toward the close-object in-focus state would increase to the point of making the total optical length too long, which is not beneficial, either.

To enhance the advantage described above, the condition(s) expressed by one or both of the following inequalities (7a) and (7b) is/are preferably satisfied:

$$0.2 < ThwG5\_G6 / fw \qquad ( 7 a )$$

$$ThwG5\_G6 / fw < 0.7 . \qquad ( 7 b )$$

More preferably, to further enhance the advantage described above, the condition(s) expressed by one or both of the following inequalities (7c) and (7d) is/are satisfied:

$$0.32 < ThwG5\_G6 / fw \qquad ( 7 c )$$

$$ThwG5\_G6 / fw < 0.6 . \qquad ( 7 d )$$

For example, the imaging optical system preferably satisfies the following inequality (8):

$$0.2 < fG 1 / fT < 1. \qquad ( 8 )$$

where fG1 is a focal length of the first lens group G1, and
fT is a focal length of the imaging optical system at a telephoto end.

The condition expressed by the inequality (8) defines the ratio of a focal length of the first lens group G1 to a focal length of the imaging optical system at a telephoto end.

If the fG1/fT ratio were less than the lower limit set by the inequality (8), then the focal length of the first lens group G1 would be so short as to make it difficult to increase the focal length of the imaging optical system at the telephoto end, which is not beneficial.

Conversely, if the fG1/fT ratio were greater than the upper limit set by the inequality (8), then the focal length of the first lens group G1 would be so long as to make the magnitude of movement of the first lens group G1 too much while the imaging optical system is zooming, which is not beneficial, either.

To enhance the advantage described above, the condition(s) expressed by one or both of the following inequalities (8a) and (8b) is/are preferably satisfied:

$$0.25 < fG 1 / fT \qquad ( 8 a )$$

$$fG 1 / fT < 0.8 . \qquad ( 8 b )$$

More preferably, to further enhance the advantage described above, the condition(s) expressed by one or both of the following inequalities (8c) and (8d) is/are satisfied:

$$0.3 < fG 1 / fT \qquad ( 8 c )$$

$$fG 1 / fT < 0.5 . \qquad ( 8 d )$$

The imaging optical system preferably satisfies the following inequality (9):

$$- 2.5 < fG 5 / fw < - 1. \qquad ( 9 )$$

where fG5 is a focal length of the fifth lens group G5, and
fw is a focal length of the imaging optical system at a wide-angle end.

The condition set by the inequality (9) defines the ratio of a focal length of the fifth lens group G5 to a focal length of the imaging optical system at a wide-angle end.

If the fG5/fw ratio were less than the lower limit set by the inequality (9), then the focal length of the fifth lens group G5 would be so short as to make it difficult to reduce the variation in aberration from the wide-angle end through the telephoto end while the imaging optical system is zooming, which is not beneficial.

Conversely, if the fG5/fw ratio were greater than the upper limit set by the inequality (9), then the focal length of the fifth lens group G5 would be so long as to make the magnitude of movement too much while the imaging optical system is focusing, which is not beneficial, either.

To enhance the advantage described above, the condition(s) expressed by one or both of the following inequalities (9a) and (9b) is/are preferably satisfied:

$$- 2.25 < fG 5 / fw \qquad ( 9 a )$$

$$fG 5 / fw < - 1.5 . \qquad ( 9 b )$$

More preferably, to further enhance the advantage described above, the condition(s) expressed by one or both of the following inequalities (9c) and (9d) is/are satisfied:

$$- 1.9 < fG 5 / fw \qquad ( 9 c )$$

$$fG 5 / fw < - 1.8 . \qquad ( 9 d )$$

For example, the imaging optical system preferably satisfies the following inequality (10):

$$0.5 < Th\_G2 \_G3 / Yw < 3. \qquad ( 10 )$$

where Th_G2_G3 is an air gap measured on the optical axis between the second lens group G2 and the third lens group G3 in the imaging optical system at a wide-angle end, and
Yw is a maximum image height of the imaging optical system at the wide-angle end.

The condition expressed by the inequality (10) defines the ratio of an air gap measured on the optical axis between the second lens group G2 and the third lens group G3 in the imaging optical system at a wide-angle end (i.e., the gap measured on the optical axis between an image-side surface of a lens located closer to the image plane than any other lens belonging to the second lens group G2 to an object-side surface of lens located closer to the object than any other lens belonging to the third lens group G3) to a maximum image height of the imaging optical system at the wide-angle end. In a camera system or an image capture device including an imaging optical system, the maximum image height of the imaging optical system at the wide-angle end may be regarded as a diagonal length, measured on an image sensor, of an imaging point corresponding to the angle of view at the wide-angle end.

If the Th_G2_G3/Yw ratio were less than the lower limit set by the inequality (10), then the interval would change so little while the imaging optical system is zooming as to make it difficult to compensate for aberrations at the time of zooming, which is not beneficial.

Conversely, if the Th_G2_G3/Yw ratio were greater than the upper limit set by the inequality (10), then the interval would change so much while the imaging optical system is zooming as to make it difficult to arrange a mechanism for causing either the second lens group G2 or the third lens group G3 to move, which is not beneficial, either.

To enhance the advantage described above, the condition(s) expressed by one or both of the following inequalities (10a) and (10b) is/are preferably satisfied:

$$0.75 < Th\_G2 \_G3 / Yw \qquad ( 10 a )$$

$$Th\_G2 \_G3 / Yw < 2. . \qquad ( 10 b )$$

More preferably, to further enhance the advantage described above, the condition(s) expressed by one or both of the following inequalities (10c) and (10d) is/are satisfied:

$$0.85 < Th\_G2 \_G3 / Yw \qquad ( 10 c )$$

$$Th\_G2 \_G3 / Yw < 1. . \qquad ( 10 d )$$

For example, the imaging optical system preferably satisfies the following inequality (11):

$$0.3 < BFw / Yw < 3. \qquad ( 11 )$$

where BFw is a back focus of the imaging optical system at a wide-angle end; and
Yw is a maximum image height of the imaging optical system at the wide-angle end.

The condition expressed by the inequality (11) defines the ratio of a back focus of the imaging optical system at a wide-angle end (i.e., the interval measured on the optical axis from a lens located closest to the image plane to the image plane S in the imaging optical system at a wide-angle end) to a maximum image height of the imaging optical system at the wide-angle end. In a camera system or an image capture device including an imaging optical system, the maximum image height of the imaging optical system at the wide-angle end may be regarded as a diagonal length, measured on an image sensor, of an imaging point corresponding to the angle of view at the wide-angle end.

If the BFw/Yw ratio were less than the lower limit set by the inequality (11), then the back focus would be so narrow as to make it difficult to arrange a member for use to couple the imaging optical system to an image sensor placed on the image plane S, which is not beneficial.

Conversely, if the BFw/Yw ratio were greater than the upper limit set by the inequality (11), then the back focus would be so wide as to make the overall size of the imaging optical system too large, which is not beneficial, either.

To enhance the advantage described above, the condition(s) expressed by one or both of the following inequalities (11a) and (11b) is/are preferably satisfied:

$$0.4 < BFw / Yw \qquad ( 11 a )$$

$$BFw / Yw < 2.4 . \qquad ( 11 b )$$

More preferably, to further enhance the advantage described above, the condition(s) expressed by one or both of the following inequalities (11c) and (11d) is/are satisfied:

$$0.5 < BFw / Yw \qquad ( 11 c )$$

$$BFw / Yw < 1.2 . \qquad ( 11 d )$$

Even more preferably, to further enhance the advantage described above, the condition(s) expressed by one or both of the following inequalities (11e) and (11f) is/are satisfied:

$$0.75 < BFw / Yw \qquad ( 11 e )$$

$$BFw / Yw < 0.9 . \qquad ( 11 f )$$

For example, the imaging optical system preferably satisfies the following inequality (12):

$$2. < TTLw / Yw < 10.0 \qquad ( 12 )$$

where TTLw is a total optical length of the imaging optical system at a wide-angle end; and
Yw is a maximum image height of the imaging optical system at the wide-angle end.

The condition expressed by the inequality (12) defines the ratio of a total optical length of the imaging optical system at a wide-angle end (i.e., the interval measured from an object-side surface of a lens located closest to the object to the image plane S in the imaging optical system) to a maximum image height of the imaging optical system at the wide-angle end. In a camera system or an image capture device including an imaging optical system, the maximum image height of the imaging optical system at the wide-angle end may be regarded as a diagonal length, measured on an image sensor, of an imaging point corresponding to the angle of view at the wide-angle end.

If the TTLw/Yw ratio were less than the lower limit set by the inequality (12), then the total optical length of the imaging optical system at the wide-angle end would be so short as to make it difficult to compensate for aberrations sufficiently, which is not beneficial.

Conversely, if the TTLw/Yw ratio were greater than the upper limit set by the inequality (12), then the total optical length of the imaging optical system at the wide-angle end would be too long, which is not beneficial, either.

To enhance the advantage described above, the condition(s) expressed by one or both of the following inequalities (12a) and (12b) is/are preferably satisfied:

$$3. < TTLw / Yw \qquad ( 12 a )$$

$$TTLw / Yw < 8. . \qquad ( 12 b )$$

More preferably, to further enhance the advantage described above, the condition(s) expressed by one or both of the following inequalities (12c) and (12d) is/are satisfied:

$$4. < TTLw / Yw \qquad ( 12 c )$$

$$TTLw / Yw < 5.5 . \qquad ( 12 d )$$

For example, the imaging optical system preferably satisfies the following inequality (13):

$$0.1 < ( TTLt - TTLw ) / TTLt < 0.5 \qquad ( 13 )$$

where TTLt is a total optical length of the imaging optical system at a telephoto end; and
TTLw is a total optical length of the imaging optical system at a wide-angle end.

The condition expressed by the inequality (13) defines the ratio of the difference between the total optical length of the imaging optical system at the telephoto end and the total optical length of the imaging optical system at the wide-angle end to the total optical length of the imaging optical system at the telephoto end. Note that the total optical length of the imaging optical system is the interval from an object-side surface of a lens located closest to the object in the imaging optical system to the image plane S.

If the (TTLt−TTLw)/TTLt ratio were less than the lower limit set by the inequality (13), then the total optical length would change so little while the imaging optical system is zooming as to make it difficult to ensure a sufficient zoom ratio, which is not beneficial.

Conversely, if the (TTLt−TTLw)/TTLt ratio were greater than the upper limit set by the inequality (13), then the total optical length would change so much while the imaging optical system is zooming as to make it difficult to arrange a mechanism for causing the lens groups to move, which is not beneficial, either.

To enhance the advantage described above, the condition(s) expressed by one or both of the following inequalities (13a) and (13b) is/are preferably satisfied:

$$0.2 < ( TTLt - TTLw ) / TTLt \qquad ( 13 a )$$

$$( TTLt - TTLw ) / TTLt < 0.4 . \qquad ( 13 b )$$

More preferably, to further enhance the advantage described above, the condition(s) expressed by one or both of the following inequalities (13c) and (13d) is/are satisfied:

$$0.25 < ( TTLt - TTLw ) / TTLt \qquad ( 13 c )$$

$$( TTLt - TTLw ) / TTLt < 0.3 . \qquad ( 13 d )$$

For example, in the imaging optical system, the third lens group G3 preferably includes: a group of image stabilizer lenses consisting of a plurality of lenses that move perpendicularly to the optical axis during the image stabilization; and a negative lens LG3n that does not move perpendicularly to the optical axis during the image stabilization. In the first to fifth embodiments, the negative lens LG3n may be, for example, the eleventh lens L11.

This allows for reducing the movement of the group of image stabilizer lenses during the image stabilization. This allows, even when the group of image stabilizer lenses moves perpendicularly to the optical axis, the aberrations to be compensated for sufficiently.

For example, in the imaging optical system, the third lens group G3 is preferably made up of at least four and at most six lenses.

This allows, even when the group of image stabilizer lenses moves perpendicularly to the optical axis, the aberrations caused by the group of image stabilizer lenses to be compensated for sufficiently.

For example, in the imaging optical system, the third lens group G3 preferably includes: a group of image stabilizer lenses consisting of a plurality of lenses that move perpendicularly to the optical axis during the image stabilization; and a group of fixed lenses G3Obj located closer to the object than the group of image stabilizer lenses is, consisting of one or more lenses, and not moving perpendicularly to the optical axis during image stabilization.

The imaging optical system preferably satisfies the following inequality (14):

$$0.01 < Th\_IS \_Obj / Yw < 1. \qquad ( 14 )$$

where Th_IS_Obj is an air gap on the optical axis between the group of image stabilizer lenses and the group of fixed lenses G3Obj, and
Yw is a maximum image height of the imaging optical system at a wide-angle end.

The condition expressed by the inequality (14) defines the ratio of an air gap on the optical axis between a group of image stabilizer lenses and a group of fixed lenses G3Obj to a maximum image height of the imaging optical system at a wide-angle end. In a camera system or an image capture device including an imaging optical system, the maximum image height of the imaging optical system at the wide-angle end may be regarded as a diagonal length, measured on an image sensor, of an imaging point corresponding to the angle of view at the wide-angle end.

If the Th_IS_Obj/Yw ratio were less than the lower limit set by the inequality (14), then the spherical aberration would be significantly positively biased (i.e., toward the positive side in the astigmatism diagram to be referred to later) over the entire zoom range, which is not beneficial.

Conversely, if the Th_IS_Obj/Yw ratio were greater than the upper limit set by the inequality (14), then the spherical aberration would be significantly negatively biased (i.e., toward the negative side in the astigmatism diagram to be referred to later) over the entire zoom range, which is not beneficial, either.

To enhance the advantage described above, the condition(s) expressed by one or both of the following inequalities (14a) and (14b) is/are preferably satisfied:

$$0.05 < Th\_IS \_Obj / Yw \qquad ( 14 a )$$

$$Th\_IS \_Obj / Yw < 0.75 . \qquad ( 14 b )$$

More preferably, to further enhance the advantage described above, the condition(s) expressed by one or both of the following inequalities (14c) and (14d) is/are satisfied:

$$0.08 < Th\_IS \_Obj / Yw \qquad ( 14 c )$$

$$Th\_IS \_Obj / Yw < 0.25 \qquad ( 14 d )$$

For example, in the imaging optical system, the third lens group G3 preferably includes: a group of image stabilizer lenses consisting of a plurality of lenses that move perpendicularly to the optical axis during the image stabilization; and a group of fixed lenses G3Obj located closer to the object than the group of image stabilizer lenses is, consisting of one or more lenses, and not moving perpendicularly to the optical axis during image stabilization.

The imaging optical system preferably satisfies the following inequality (15):

$$0.02 < Th\_IS \_Img / Yw < 1. \qquad ( 15 )$$

where Th_IS_Img is an air gap on the optical axis between the group of image stabilizer lenses and the group of fixed lenses G3Img, and
Yw is a maximum image height of the imaging optical system at a wide-angle end.

The condition expressed by the inequality (15) defines the ratio of an air gap on the optical axis between a group of image stabilizer lenses and the group of fixed lenses G3Img to a maximum image height of the imaging optical system at a wide-angle end. In a camera system or an image capture device including an imaging optical system, the maximum image height of the imaging optical system at the wide-angle end may be regarded as a diagonal length, measured on an image sensor, of an imaging point corresponding to the angle of view at the wide-angle end.

If the Th_IS_Img/Yw ratio were less than the lower limit set by the inequality (15), then the spherical aberration would be significantly positively biased (i.e., toward the positive side in the astigmatism diagram to be referred to later) over the entire zoom range, which is not beneficial.

Conversely, if the Th_IS_Img/Yw ratio were greater than the upper limit set by the inequality (15), then the spherical aberration would be significantly negatively biased (i.e., toward the negative side in the astigmatism diagram to be referred to later) over the entire zoom range, which is not beneficial, either.

To enhance the advantage described above, the condition(s) expressed by one or both of the following inequalities (15a) and (15b) is/are preferably satisfied:

$$0.05 < Th\_IS \_Img / Yw \qquad ( 15 a )$$

$$Th\_IS \_Img / Yw < 0 \text{.50} . \qquad ( 15 b )$$

More preferably, to further enhance the advantage described above, the condition(s) expressed by one or both of the following inequalities (15c) and (15d) is/are satisfied:

$$0.08 < Th\_IS \_Img / Yw \qquad ( 15 c )$$

$$Th\_IS \_Img / Yw < 0.15 . \qquad ( 15 d )$$

In the first to fifth embodiments described above, an imaging optical system which includes an aperture stop A located closer to the object than any other member of the third lens group G3 and moving along with the lenses of the third lens group G3 while the imaging optical system is zooming has been described as an exemplary arrangement in which the third lens group G3 includes the aperture stop A. However, this is only an example and should not be construed as limiting. Alternatively, the third lens group G3 may include the aperture stop A located closer to the image plane than any other member of the third lens group G3 is and moving along with the lenses of the third lens group G3 while the imaging optical system is zooming. Still alternatively, the second lens group G2 may include the aperture stop A located closer to the image plane than any other member of the second lens group G2 is and moving along with the lenses of the second lens group G2 while the imaging optical system is zooming. Yet alternatively, the aperture stop A may also be provided between the second lens group G2 and the third lens group G3 to move independently of the second lens group G2 and the third lens group G3 while the imaging optical system is zooming.

Nevertheless, providing the third lens group G3 with the aperture stop A located closer to the object than any other member of the third lens group G3 is and moving along with the lenses of the third lens group G3 while the imaging optical system is zooming may reduce the chances of the effective diameter of the frontend lens (i.e., the first lens L1) increasing too much.

Optionally, if the complexity of a cam mechanism for use to make zooming is allowable, then controlling the aperture stop A to move independently of the second lens group G2 and the third lens group G3 also reduces the chances of the effective diameter of the frontend lens (i.e., the first lens L1) increasing too much.

### Schematic Configuration for Image Capture Device to which First Embodiment is Applied

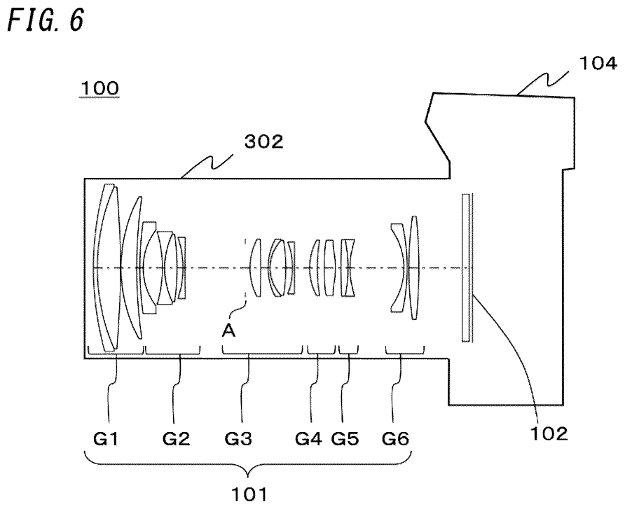

FIG. 6 illustrates a schematic configuration for an image capture device, to which the imaging optical system of the first embodiment is applied. Alternatively, the imaging optical system according to the second, third, fourth, or fifth embodiment is also applicable to the image capture device.

The image capture device 100 includes a housing 104, an image sensor 102, and the imaging optical system 101 according to the first embodiment. Specifically, the image capture device 100 may be implemented as a digital camera, for example.

The housing 104 includes a lens barrel 302. The lens barrel 302 holds the respective lens groups and the aperture stop A that form the imaging optical system 101.

The image sensor 102 is disposed at the image plane S of the imaging optical system according to the first embodiment.

In the imaging optical system 101, the first lens group G1, the second lens group G2, the third lens group G3, the fourth lens group G4, the fifth lens group G5, and the sixth lens group G6 are attached to, or engaged with, a lens frame included in the lens barrel 302 so as to move while the imaging optical system 101 is zooming.

This provides an image capture device with the ability to compensate for various types of aberrations sufficiently.

In the example described above, the imaging optical system according to the first embodiment is applied to a digital camera. However, this is only an example and should not be construed as limiting. Alternatively, the imaging optical system is also applicable to a surveillance camera, a smartphone, or any of various other types of image capture devices.

### Schematic Configuration for Camera System to which First Embodiment is Applied

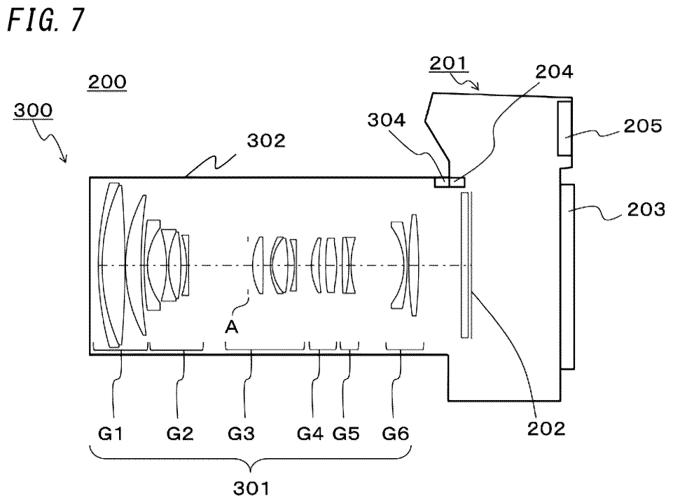

FIG. 7 illustrates a schematic configuration for a camera system, to which the imaging optical system of the first embodiment is applied. Alternatively, the imaging optical system according to the second, third, fourth, or fifth embodiment is also applicable to the camera system.

The camera system 200 includes a camera body 201 and an interchangeable lens unit 300 to be connected removably to the camera body 201.

The camera body 201 includes an image sensor 202, a monitor 203, a memory, a camera mount 204, and a viewfinder 205. The image sensor 202 receives an optical image formed by the imaging optical system 301 of the interchangeable lens unit 300 and transforms the optical image into an electrical image signal. The monitor 203 displays the image signal transformed by the image sensor 202. The memory stores the image signal.

The imaging optical system 301 of the interchangeable lens unit 300 is the imaging optical system according to the first embodiment.

The interchangeable lens unit 300 includes not only the imaging optical system 301 but also a lens barrel 302 and a lens mount 304 as well. The lens barrel 302 holds the respective lens groups and aperture stop A that form the imaging optical system 301. The lens mount 304 is to be connected to the camera mount 204 of the camera body 201.

The camera mount 204 and the lens mount 304 are physically connected together. In addition, the camera mount 204 and the lens mount 304 also electrically connect together a controller in the camera body 201 and a controller in the interchangeable lens unit 300. That is to say, the camera mount 204 and the lens mount 304 serve as interfaces that allow themselves to exchange signals with each other.

In the imaging optical system 301, the first lens group G1, the second lens group G2, the third lens group G3, the fourth lens group G4, the fifth lens group G5, and the sixth lens group G6 are attached to, or engaged with, a lens frame included in the lens barrel 302 so as to be movable while the imaging optical system 301 is zooming.

In the camera system 200 including the respective lens groups held by the lens barrel 302 and the camera body 201, an actuator, a lens frame, and other members to be controlled by the controller in the interchangeable lens unit 300 are provided such that the fifth lens group G5 may move while the imaging optical system 301 is focusing.

### Examples of Numerical Values

Next, exemplary sets of specific numerical values that were actually adopted in the imaging optical systems with the configurations according to the first, second, third, fourth, and fifth embodiments will be described. Note that in the tables showing these exemplary sets of numerical values, the length is expressed in millimeters (mm), the angle of view is expressed in degrees (°), r indicates the radius of curvature, d indicates the surface interval, nd indicates a refractive index in response to a d-line, vd (also denoted as “vd”) indicates an abbe number in response to a d-line, and a surface with an asterisk (*) is an aspheric surface. The aspheric shape is defined by the following equation.

$$Z = \frac{{h}^{2} / r}{1 + \sqrt{1 - ( 1 + κ ) {( h / r )}^{2}}} + \sum {A}_{n} {h}^{n}$$

where Z is the distance from a point on an aspheric surface, located at a height h measured from the optical axis, to a tangent plane defined with respect to the vertex of the aspheric surface, h is the height as measured from the optical axis, r is the radius of curvature of the vertex, K is a conic constant, and An is an n^{th} order aspheric surface coefficient.

FIGS. 1B, 2B, 3B, 4B, and 5B are longitudinal aberration diagrams showing what state the imaging optical systems according to the first, second, third, fourth, and fifth embodiments assume.

In each longitudinal aberration diagram, portion (a) shows the longitudinal aberrations at the wide-angle end, portion (b) shows the longitudinal aberrations at the middle position, and portion (c) shows the longitudinal aberrations at the telephoto end. Each of portions (a), (b) and (c) of these longitudinal aberration diagrams shows spherical aberration (SA (mm)), astigmatism (AST (mm)), and distortion (DIS (%)) in this order from left to right. In each spherical aberration diagram, the ordinate indicates the F number (designated by “F” on the drawings), the solid curve indicates a characteristic in response to a d-line, the shorter dashed curve indicates a characteristic in response to an F-line, and the longer dashed curve indicates a characteristic in response to a C-line. In each astigmatism diagram, the ordinate indicates the image height (designated by “H” on the drawings), the solid curve indicates a characteristic with respect to a sagittal plane (designated by “s” on the drawings), and the dotted curve indicates a characteristic with respect to a meridional plane (designated by “m” on the drawings). Furthermore, in each distortion diagram, the ordinate indicates the image height (designated by “H” on the drawings).

FIGS. 1C, 2C, 3C, 4C, and 5C are lateral aberration diagrams showing what state the imaging optical systems according to the first, second, third, fourth, and fifth embodiments assume at the telephoto end.

In each lateral aberration diagram, the upper three aberration diagrams represent a basic state where no image blur compensation is performed at the telephoto end. On the other hand, the lower three aberration diagrams represent an image blur compensated state where the group of image stabilizer lenses is moved to a predetermined degree perpendicularly to the optical axis at the telephoto end. In the three lateral aberration diagrams representing the basic state, the upper graph shows lateral aberration at an image point corresponding to 70% of the maximum image height. The middle graph shows the lateral aberration at an axial image point. The lower graph shows lateral aberration at an image point corresponding to −70% of the maximum image height. In the three lateral aberration diagrams representing the image blur compensated state, the upper graph shows lateral aberration at an image point corresponding to 70% of the maximum image height. The middle graph shows lateral aberration at an axial image point. The lower graph shows lateral aberration at an image point corresponding to −70% of the maximum image height. Also, in each lateral aberration diagram, the abscissa indicates the distance from a principal ray on the pupil plane. The solid curve indicates a characteristic in response to a d-line. The shorter dashed curve indicates a characteristic in response to an F-line. The longer dashed curve indicates a characteristic in response to a C-line.

Note that in the imaging optical systems according to the respective examples of numerical values, the magnitudes of movement of the group of image stabilizer lenses in a direction perpendicular to the optical axis at the telephoto end are as follows:
First example of numerical values: 0.340 mm
Second example of numerical values: 0.350 mm
Third example of numerical values: 0.348 mm
Fourth example of numerical values: 0.351 mm
Fifth example of numerical values: 0.349 mm

At the telephoto end at which the shooting distance is infinite (∞), the magnitude of image eccentricity in a situation where the imaging optical system is tilted to 0.3 degrees is equal to the magnitude of image eccentricity in a situation where the group of image stabilizer lenses makes parallel displacement by a distance represented by any of these numerical values in a direction perpendicular to the optical axis.

As can be seen from these lateral aberration diagrams, the lateral aberration at the axial image point has a sufficient degree of symmetry. It can also be seen that comparing the lateral aberration at an image point corresponding to +70% of the maximum image height with the lateral aberration at an image point corresponding to −70% of the maximum image height in the basic state, their degrees of curvature are both small and their aberration curves have an approximately equal tilt, and therefore, their eccentricity coma aberration and eccentricity astigmatism are both insignificant. This means that even in the image blur compensated state, sufficiently good imaging performance is achieved. In addition, supposing the imaging optical systems have the same image blur compensation angle, as the focal length of the entire imaging optical system shortens, the magnitude of parallel displacement required for image blur compensation decreases. This allows the image blur compensation to be done to a sufficient degree at any zoom position with respect to an image blur compensation angle of about 0.3 degrees without causing a decline in imaging performance.

### First Example of Numerical Values

Following is a first exemplary set of numerical values for the imaging optical system corresponding to the first embodiment shown in FIG. 1A. Specifically, as the first example of numerical values for the imaging optical system, surface data is shown in Table 1A, aspheric surface data is shown in Table 1B, and various types of data in the infinity in-focus state are shown in Tables 1C-1F.

TABLE 1A
(Surface data)

| | | | | | Effective |
|---|---|---|---|---|---|
| Surface No. | r | d | nd | vd | diameter |
| Object surface | ∞ | | | | |
| 1 | 90.10290 | 1.20000 | 1.84666 | 23.8 | 24.773 |
| 2 | 59.23570 | 6.93240 | 1.49700 | 81.6 | 23.749 |
| 3 | −280.94820 | 0.20000 | | | 23.386 |
| 4 | 44.38180 | 4.64010 | 1.49700 | 81.6 | 20.573 |
| 5 | 141.93270 | Variable | | | 20.258 |
| 6 | 96.78490 | 1.00000 | 1.95347 | 32.6 | 13.231 |
| 7 | 18.86630 | 5.70110 | | | 10.904 |
| 8 | −38.17850 | 0.65900 | 1.59462 | 66.8 | 10.436 |
| 9 | 23.41150 | 3.68120 | 1.86672 | 19.8 | 9.594 |
| 10 | −69.86610 | 1.74760 | | | 9.358 |
| 11 | −29.23560 | 0.60000 | 1.88300 | 40.8 | 8.624 |
| 12 | 542.90170 | Variable | | | 8.369 |
| 13 (Aperture) | ∞ | 1.40000 | | | 7.176 |
| 14 | 18.33090 | 3.15260 | 1.52711 | 57.2 | 8.087 |
| 15 | −378.74380 | 2.24620 | | | 8.070 |
| 16 | 18.17170 | 0.60000 | 1.95698 | 32.3 | 8.050 |
| 17 | 12.06780 | 4.65620 | 1.52092 | 60.8 | 7.669 |
| 18 | −49.83060 | 1.96370 | | | 7.515 |
| 19 | −22.70500 | 0.60000 | 1.99236 | 29.7 | 7.160 |
| 20 | −843.60570 | Variable | | | 7.254 |
| 21 | 17.31530 | 2.29190 | 1.49700 | 81.6 | 7.832 |
| 22 | 47.62670 | 2.13040 | | | 7.735 |
| 23* | 71.12630 | 3.30940 | 1.58699 | 59.5 | 7.622 |
| 24* | −28.91280 | Variable | | | 7.707 |
| 25 | 216.95880 | 2.02110 | 1.94372 | 18.0 | 8.379 |
| 26 | −40.67040 | 0.60000 | 1.80334 | 32.2 | 8.401 |
| 27 | 27.07710 | Variable | | | 8.420 |
| 28 | −19.87370 | 1.00000 | 1.82868 | 43.1 | 11.234 |
| 29 | −58.94070 | 0.50000 | | | 12.663 |
| 30 | 109.76350 | 2.96010 | 1.76918 | 34.3 | 14.777 |
| 31 | −144.98430 | Variable | | | |
| 32 | ∞ | 2.10000 | 1.51680 | 64.2 | |
| 33 | ∞ | 1.00000 | | | |
| 34 | ∞ | BF | | | |
| Image plane | ∞ | | | | |

TABLE 1B
(Aspheric surface data)

23^{rd} surface
K = 2.63837E+00, A4 = −3.75089E−05, A6 = 7.29717E−07, A8 =
8.23449E−10 A10 = 9.78133E−11, A12 = −5.65229E−13
24^{th} surface
K = −4.87684E−01, A4 = 4.48028E−05, A6 = 7.78441E−07, A8 =
3.87499E−10 A10 = 1.12740E−10, A12 = −3.25867E−13

(Various Types of Data in Infinity in-Focus State)

TABLE 1C
(Various types of data)
(Zoom ratio: 6.65091)

| | Wide-angle | Middle | Telephoto |
|---|---|---|---|
| Focal length | 28.9887 | 74.7234 | 192.8010 |
| F number | 4.16046 | 5.80386 | 7.38074 |
| Angle of view | 37.1877 | 15.4912 | 6.1980 |
| Image height | 21.1600 | 21.6300 | 21.6300 |
| Total lens length | 112.8021 | 138.1617 | 158.9887 |
| BF | 0.00000 | 0.00000 | 0.00000 |
| d5 | 0.9677 | 19.9101 | 35.5300 |
| d12 | 17.9193 | 9.4440 | 1.7944 |
| d20 | 4.4987 | 2.4455 | 0.8000 |
| d24 | 1.7038 | 2.8663 | 3.5734 |
| d27 | 15.9632 | 16.1916 | 19.4165 |
| d31 | 12.8500 | 28.4927 | 38.9884 |
| Entrance pupil position | 28.2608 | 72.2588 | 143.0679 |
| Exit pupil position | −45.4074 | −59.6027 | −70.4186 |
| Anterior principal point | 38.7453 | 53.1738 | −192.0587 |
| Posterior principal point | 83.8134 | 63.4383 | −33.8123 |

TABLE 1D
(Data about single lenses)

| Lens | Start surface | Focal length |
|---|---|---|
| 1 | 1 | −207.9336 |
| 2 | 2 | 99.1038 |
| 3 | 4 | 127.9079 |
| 4 | 6 | −24.7328 |
| 5 | 8 | −24.3089 |
| 6 | 9 | 20.6097 |
| 7 | 11 | −31.4021 |
| 8 | 14 | 33.2620 |
| 9 | 16 | −39.4375 |
| 10 | 17 | 19.1431 |
| 11 | 19 | −23.5211 |
| 12 | 21 | 53.4015 |
| 13 | 23 | 35.4544 |
| 14 | 25 | 36.4314 |
| 15 | 26 | −20.1547 |
| 16 | 28 | −36.6072 |
| 17 | 30 | 81.6285 |

TABLE 1E
(Data about zoom lens groups)

| | | | Lens | Anterior | Posterior |
|---|---|---|---|---|---|
| | Start | Focal | configuration | principal | principal |
| Group | surface | length | length | point | point |
| 1 | 1 | 77.21746 | 12.97250 | 2.91283 | 7.28168 |
| 2 | 6 | −13.77232 | 13.38890 | 3.73110 | 7.73141 |
| 3 | 13 | 37.13341 | 14.61870 | −7.62613 | −0.25443 |
| 4 | 21 | 22.84467 | 7.73170 | 2.99875 | 4.56417 |
| 5 | 25 | −46.14273 | 2.62110 | 1.71174 | 2.94933 |
| 6 | 28 | −69.55417 | 4.46010 | −2.03613 | −0.40964 |

TABLE 1F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 6 | −0.25958 | −0.40373 | −0.74472 |
| 3 | 13 | 9.68185 | 3.59628 | 2.79645 |
| 4 | 21 | −0.07097 | −0.24333 | −0.36531 |
| 5 | 25 | 1.63280 | 1.81060 | 1.97146 |
| 6 | 28 | 1.28914 | 1.51277 | 1.66474 |

### Second Example of Numerical Values

Following is a second exemplary set of numerical values for the imaging optical system corresponding to the second embodiment shown in FIG. 2A. Specifically, as the second example of numerical values for the imaging optical system, surface data is shown in Table 2A, aspheric surface data is shown in Table 2B, and various types of data in the infinity in-focus state are shown in Tables 2C-2F.

TABLE 2A
(Surface data)

| | | | | | Effective |
|---|---|---|---|---|---|
| Surface No. | r | d | nd | vd | diameter |
| Object surface | ∞ | | | | |
| 1 | 93.38500 | 1.20000 | 1.84666 | 23.8 | 24.106 |
| 2 | 60.44080 | 6.47880 | 1.49700 | 81.6 | 22.821 |
| 3 | −254.35560 | 0.20000 | | | 22.413 |
| 4 | 43.18570 | 4.24470 | 1.49700 | 81.6 | 18.739 |
| 5 | 157.09070 | Variable | | | 18.462 |
| 6 | 139.63390 | 1.00000 | 1.92003 | 35.9 | 13.202 |
| 7 | 18.94060 | 5.54740 | | | 10.831 |
| 8 | −39.96360 | 0.65900 | 1.59341 | 67.0 | 10.393 |
| 9 | 23.14480 | 3.69620 | 1.86317 | 20.3 | 9.586 |
| 10 | −70.87870 | 2.32030 | | | 9.354 |
| 11 | −26.99070 | 0.60000 | 1.88296 | 40.8 | 8.267 |
| 12 | 1528.98670 | Variable | | | 8.043 |
| 13 (Aperture) | ∞ | 1.40000 | | | 7.176 |
| 14 | 19.79540 | 3.25900 | 1.52986 | 55.8 | 8.146 |
| 15 | −105.27840 | 2.23430 | | | 8.149 |
| 16 | 18.76860 | 0.60000 | 1.96234 | 31.8 | 8.061 |
| 17 | 12.45390 | 4.44460 | 1.53351 | 54.0 | 7.698 |
| 18 | −58.18580 | 1.72980 | | | 7.545 |
| 19 | −24.36650 | 0.60000 | 1.97700 | 30.8 | 7.270 |
| 20 | 135.37870 | Variable | | | 7.358 |
| 21 | 19.29630 | 3.21910 | 1.49700 | 81.6 | 8.131 |
| 22 | −144.37450 | 3.25250 | | | 8.068 |
| 23* | 450.22950 | 1.99400 | 1.58699 | 59.5 | 7.682 |
| 24* | −28.52620 | Variable | | | 7.719 |
| 25 | −354.64850 | 2.09280 | 1.94798 | 19.5 | 8.352 |
| 26 | −30.10550 | 0.60000 | 1.80449 | 31.4 | 8.400 |
| 27 | 32.88070 | Variable | | | 8.487 |
| 28 | −22.02600 | 1.00000 | 1.79990 | 44.5 | 11.542 |
| 29 | −64.36980 | 0.67320 | | | 12.806 |
| 30 | 252.42800 | 2.49780 | 1.84568 | 22.3 | 14.371 |
| 31 | −113.60360 | Variable | | | |
| 32 | ∞ | 2.10000 | 1.51680 | 64.2 | |
| 33 | ∞ | 1.00000 | | | |
| 34 | ∞ | BF | | | |
| Image plane | ∞ | | | | |

TABLE 2B
(Aspheric surface data)

23^{rd} surface
K = −5.00000E+00, A4 = −6.80359E−05, A6 = 9.24863E−07,
A8 = −5.33973E−09 A10 = 3.23148E−10, A12 = −1.78860E−12
24^{th} surface
K = 1.81265E+00, A4 = 1.89226E−05, A6 = 1.01029E−06,
A8 = −5.28472E−09 A10 = 3.04395E−10, A12 = −1.23164E−12

(Various Types of Data in Infinity in-Focus State)

TABLE 2C
(Various types of data)
(Zoom ratio: 6.65357)

| | Wide-angle | Middle | Telephoto |
|---|---|---|---|
| Focal length | 28.9794 | 74.7361 | 192.8162 |
| F number | 4.16053 | 5.95443 | 7.38165 |
| Angle of view | 36.7545 | 15.4926 | 6.1304 |
| Image height | 20.4600 | 21.6300 | 21.6300 |
| Total lens length | 112.7930 | 137.6008 | 158.9777 |
| BF | 0.00000 | 0.00000 | 0.00000 |
| d5 | 1.1516 | 17.8465 | 34.4419 |
| d12 | 16.8378 | 8.3951 | 1.7654 |
| d20 | 4.2308 | 2.2115 | 0.8000 |
| d24 | 2.2799 | 4.6044 | 4.3321 |
| d27 | 16.7837 | 14.4138 | 20.4596 |
| d31 | 12.8500 | 31.5471 | 38.5534 |
| Entrance pupil position | 27.4907 | 64.5952 | 141.2994 |
| Exit pupil position | −47.5629 | −63.4954 | −72.2329 |
| Anterior principal point | 38.8192 | 51.2798 | −180.7116 |
| Posterior principal point | 83.8136 | 62.8646 | −33.8385 |

TABLE 2D
(Data about single lenses)

| Lens | Start surface | Focal length |
|---|---|---|
| 1 | 1 | −205.7934 |
| 2 | 2 | 98.9385 |
| 3 | 4 | 118.3732 |
| 4 | 6 | −23.9126 |
| 5 | 8 | −24.6030 |
| 6 | 9 | 20.5882 |
| 7 | 11 | −30.0329 |
| 8 | 14 | 31.7333 |
| 9 | 16 | −40.3441 |
| 10 | 17 | 19.6582 |
| 11 | 19 | −21.0969 |
| 12 | 21 | 34.4734 |
| 13 | 23 | 45.7726 |
| 14 | 25 | 34.5949 |
| 15 | 26 | −19.4527 |
| 16 | 28 | −42.3033 |
| 17 | 30 | 92.9322 |

TABLE 2E
(Data about zoom lens groups)

| | | | Lens | Anterior | Posterior |
|---|---|---|---|---|---|
| | Start | Focal | configuration | principal | principal |
| Group | surface | length | length | point | point |
| 1 | 1 | 73.83046 | 12.12350 | 3.02330 | 7.09929 |
| 2 | 6 | −13.14402 | 13.82290 | 3.89670 | 8.10468 |
| 3 | 13 | 41.22271 | 14.26770 | −9.88613 | −1.73997 |
| 4 | 21 | 21.35212 | 8.46560 | 3.21513 | 4.46051 |
| 5 | 25 | −44.61667 | 2.69280 | 1.30544 | 2.59593 |
| 6 | 28 | −81.62064 | 4.17100 | −2.45525 | −1.00244 |

TABLE 2F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 6 | −0.25969 | −0.38751 | −0.75873 |
| 3 | 13 | 3.43654 | 2.19760 | 2.01004 |
| 4 | 21 | −0.20823 | −0.43179 | −0.52973 |
| 5 | 25 | 1.68946 | 1.86214 | 2.06594 |
| 6 | 28 | 1.25023 | 1.47836 | 1.56472 |

### Third Example of Numerical Values

Following is a third exemplary set of numerical values for the imaging optical system corresponding to the third embodiment shown in FIG. 3A. Specifically, as the third example of numerical values for the imaging optical system, surface data is shown in Table 3A, aspheric surface data is shown in Table 3B, and various types of data in the infinity in-focus state are shown in Tables 3C-3F.

TABLE 3A
(Surface data)

| | | | | | Effective |
|---|---|---|---|---|---|
| Surface No. | r | d | nd | vd | diameter |
| Object surface | ∞ | | | | |
| 1 | 89.39310 | 1.20000 | 1.84666 | 23.8 | 24.744 |
| 2 | 59.08770 | 7.01900 | 1.49700 | 81.6 | 23.412 |
| 3 | −261.65280 | 0.20000 | | | 22.887 |
| 4 | 43.01610 | 4.49310 | 1.49700 | 81.6 | 20.080 |
| 5 | 119.92310 | Variable | | | 19.741 |
| 6 | 83.79430 | 1.00000 | 1.95302 | 32.7 | 13.669 |
| 7 | 18.79360 | 6.51330 | | | 11.226 |
| 8 | −36.45670 | 0.65900 | 1.59342 | 67.0 | 10.442 |
| 9 | 23.05660 | 3.70870 | 1.86837 | 20.4 | 9.583 |
| 10 | −70.68230 | 1.78390 | | | 9.346 |
| 11 | −28.97300 | 0.60000 | 1.88294 | 40.8 | 8.597 |
| 12 | 767.52780 | Variable | | | 8.347 |
| 13 (Aperture) | ∞ | 1.40000 | | | 7.175 |
| 14 | 18.98150 | 3.15730 | 1.52706 | 57.3 | 8.027 |
| 15 | −164.90740 | 1.99820 | | | 8.025 |
| 16 | 18.42970 | 0.60000 | 1.95402 | 32.6 | 8.006 |
| 17 | 12.18010 | 4.55670 | 1.52181 | 60.3 | 7.631 |
| 18 | −51.19390 | 1.70990 | | | 7.474 |
| 19 | −23.77660 | 0.60000 | 1.99578 | 29.5 | 7.152 |
| 20 | −689.93870 | Variable | | | 7.228 |
| 21 | 20.06570 | 2.48940 | 1.49700 | 81.6 | 7.869 |
| 22 | 146.51020 | 2.99990 | | | 7.789 |
| 23* | 292.70690 | 2.07450 | 1.58699 | 59.5 | 7.540 |
| 24* | −27.59030 | Variable | | | 7.600 |
| 25 | 290.10420 | 2.11100 | 1.95145 | 18.7 | 8.370 |
| 26 | −36.00030 | 0.60000 | 1.80342 | 32.2 | 8.401 |
| 27 | 28.04480 | Variable | | | 8.439 |
| 28 | −18.84090 | 1.00000 | 1.84252 | 42.4 | 10.951 |
| 29 | −57.14670 | 0.58670 | | | 12.440 |
| 30 | 122.40400 | 3.20170 | 1.74466 | 38.7 | 14.625 |
| 31 | −99.94240 | Variable | | | |
| 32 | ∞ | 2.10000 | 1.51680 | 64.2 | |
| 33 | ∞ | 1.00000 | | | |
| 34 | ∞ | BF | | | |
| Image plane | ∞ | | | | |

TABLE 3B
(Aspheric surface data)

23^{rd} surface
K = 5.00000E+00, A4 = −5.96112E−05, A6 = 8.16552E−07, A8 =
8.09756E−10 A10 = 1.98774E−10, A12 = −8.27231E−13
24^{th} surface
K = 1.88093E+00, A4 = 2.67197E−05, A6 = 8.11536E−07, A8 =
2.85280E−09 A10 = 1.42987E−10, A12 = −8.71894E−15

(Various Types of Data in Infinity in-Focus State)

TABLE 3C
(Various types of data)
(Zoom ratio: 6.65330)

| | Wide-angle | Middle | Telephoto |
|---|---|---|---|
| Focal length | 28.9799 | 74.7535 | 192.8118 |
| F number | 4.15987 | 5.71599 | 7.38089 |
| Angle of view | 36.7522 | 15.4855 | 6.2115 |
| Image height | 20.8800 | 21.6300 | 21.6300 |
| Total lens length | 112.0885 | 135.2097 | 158.9524 |
| BF | 0.00000 | 0.00000 | 0.00000 |
| d5 | 0.6000 | 19.4360 | 35.6171 |
| d12 | 17.7695 | 8.4958 | 1.7816 |
| d20 | 4.7515 | 2.2708 | 0.8500 |
| d24 | 1.7084 | 3.6014 | 2.8630 |
| d27 | 15.0738 | 15.4479 | 18.2846 |
| d31 | 12.8500 | 26.6238 | 40.2372 |
| Entrance pupil position | 28.2888 | 71.1897 | 146.8197 |
| Exit pupil position | −44.9962 | −57.2933 | −71.0917 |
| Anterior principal point | 38.5930 | 48.3602 | −183.6243 |
| Posterior principal point | 83.1086 | 60.4561 | −33.8594 |

TABLE 3D
(Data about single lenses)

| Lens | Start surface | Focal length |
|---|---|---|
| 1 | 1 | −209.6654 |
| 2 | 2 | 97.6971 |
| 3 | 4 | 132.3948 |
| 4 | 6 | −25.6140 |
| 5 | 8 | −23.7034 |
| 6 | 9 | 20.3957 |
| 7 | 11 | −31.6093 |
| 8 | 14 | 32.4892 |
| 9 | 16 | −39.5012 |
| 10 | 17 | 19.3326 |
| 11 | 19 | −24.7408 |
| 12 | 21 | 46.4771 |
| 13 | 23 | 43.0576 |
| 14 | 25 | 33.7670 |
| 15 | 26 | −19.5398 |
| 16 | 28 | −33.7648 |
| 17 | 30 | 74.3420 |

TABLE 3E
(Data about zoom lens groups)

| | Start | | Lens configuration | Anterior | Posterior |
|---|---|---|---|---|---|
| Group | surface | Focal length | length | principal point | principal point |
| 1 | 1 | 77.61111 | 12.91210 | 2.78850 | 7.14845 |
| 2 | 6 | −13.87490 | 14.26490 | 4.06986 | 8.26886 |
| 3 | 13 | 35.90345 | 14.02210 | −6.13051 | 0.40724 |
| 4 | 21 | 23.98849 | 7.56380 | 3.14279 | 4.29647 |
| 5 | 25 | −47.39546 | 2.71100 | 1.70770 | 2.99547 |
| 6 | 28 | −65.78898 | 4.78840 | −2.41412 | −0.76204 |

TABLE 3F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 6 | −0.26030 | −0.40256 | −0.75879 |
| 3 | 13 | 45.92215 | 4.44253 | 3.64379 |
| 4 | 21 | −0.01490 | −0.20220 | −0.27093 |
| 5 | 25 | 1.59403 | 1.74678 | 1.91530 |
| 6 | 28 | 1.31552 | 1.52487 | 1.73156 |

### Fourth Example of Numerical Values

Following is a fourth exemplary set of numerical values for the imaging optical system corresponding to the fourth embodiment shown in FIG. 4A. Specifically, as the fourth example of numerical values for the imaging optical system, surface data is shown in Table 4A, aspheric surface data is shown in Table 4B, and various types of data in the infinity in-focus state are shown in Tables 4C-4F.

TABLE 4A
(Surface data)

| | | | | | Effective |
|---|---|---|---|---|---|
| Surface No. | r | d | nd | vd | diameter |
| Object surface | ∞ | | | | |
| 1 | 91.07200 | 1.20000 | 1.84666 | 23.8 | 23.451 |
| 2 | 58.45620 | 6.32950 | 1.49700 | 81.6 | 22.172 |
| 3 | −230.31680 | 0.20000 | | | 21.667 |
| 4 | 41.41310 | 4.23200 | 1.49700 | 81.6 | 18.804 |
| 5 | 119.66320 | Variable | | | 18.488 |
| 6 | 93.92320 | 1.00000 | 1.95152 | 32.8 | 13.251 |
| 7 | 18.22590 | 6.01180 | | | 10.904 |
| 8 | −40.06930 | 0.65900 | 1.59353 | 67.0 | 10.357 |
| 9 | 21.45130 | 3.92760 | 1.86886 | 20.9 | 9.577 |
| 10 | −65.44920 | 2.14870 | | | 9.350 |
| 11 | −26.64300 | 0.60000 | 1.88300 | 40.8 | 8.365 |
| 12 | 2000.00000 | Variable | | | 8.142 |
| 13 (Aperture) | ∞ | 1.40000 | | | 7.175 |
| 14 | 19.66100 | 3.09460 | 1.53232 | 54.6 | 8.020 |
| 15 | −150.34770 | 2.21410 | | | 8.027 |
| 16 | 18.41180 | 0.60000 | 1.99890 | 28.9 | 8.022 |
| 17 | 12.34910 | 4.45180 | 1.53512 | 53.3 | 7.654 |
| 18 | −56.62900 | 1.74820 | | | 7.504 |
| 19 | −24.57010 | 0.60000 | 1.97345 | 30.6 | 7.211 |
| 20 | 121.62620 | Variable | | | 7.294 |
| 21 | 19.22620 | 2.92120 | 1.49700 | 81.6 | 7.868 |
| 22 | −335.45030 | 2.68680 | | | 7.817 |
| 23* | 132.83390 | 2.88940 | 1.58699 | 59.5 | 7.578 |
| 24* | −29.23300 | Variable | | | 7.659 |
| 25 | 1125.71610 | 2.21030 | 1.94899 | 18.4 | 8.364 |
| 26 | −30.82570 | 0.60000 | 1.79893 | 30.9 | 8.400 |
| 27 | 30.24630 | Variable | | | 8.446 |
| 28 | −19.92460 | 1.00000 | 1.80520 | 44.2 | 10.719 |
| 29 | −56.08430 | 0.50000 | | | 11.942 |
| 30 | 141.20860 | 3.34570 | 1.80918 | 33.9 | 13.536 |
| 31 | −65.96530 | Variable | | | 13.858 |
| 32 | −77.85290 | 0.90000 | 1.99402 | 29.6 | 15.706 |
| 33 | −271.88690 | Variable | | | 16.116 |
| 34 | ∞ | 2.10000 | 1.51680 | 64.2 | |
| 35 | ∞ | 1.00000 | | | |
| 36 | ∞ | BF | | | |
| Image plane | ∞ | | | | |

TABLE 4B
(Aspheric surface data)

23rd surface
K = 0.00000E+00, A4 = −3.45181E−05, A6 = 7.54614E−07, A8 = 1.49928E−09
A10 = 9.30690E−11, A12 = −5.69505E−13
24th surface
K = 0.00000E+00, A4 = 4.14702E−05, A6 = 8.08831E−07, A8 = 1.34409E−09
A10 = 1.01596E−10, A12 = −3.07347E−13

(Various Types of Data in Infinity in-Focus State)

TABLE 4C
(Various types of data)
(Zoom ratio: 6.66602)

| | Wide-angle | Middle | Telephoto |
|---|---|---|---|
| Focal length | 28.9279 | 74.7073 | 192.8342 |
| F number | 4.16045 | 5.74141 | 7.38120 |
| Angle of view | 36.7900 | 15.4990 | 6.1612 |
| Image height | 20.6900 | 21.6300 | 21.6300 |
| Total lens length | 112.8085 | 136.0732 | 158.9817 |
| BF | 0.00000 | 0.00000 | 0.00000 |
| d5 | 0.6000 | 18.2707 | 34.7853 |
| d12 | 17.1989 | 7.7230 | 1.7618 |
| d20 | 4.0249 | 1.9070 | 0.8500 |
| d24 | 2.2953 | 3.9935 | 2.6926 |
| d27 | 14.4230 | 13.1757 | 17.7055 |
| d31 | 0.8329 | 16.5345 | 12.9388 |
| d33 | 12.8500 | 13.8927 | 27.6909 |
| Entrance pupil position | 26.9806 | 65.8742 | 143.5504 |
| Exit pupil position | −44.7949 | −51.8512 | −64.6710 |
| Anterior principal point | 37.2326 | 32.9545 | −238.7267 |
| Posterior principal point | 83.8806 | 61.3660 | −33.8525 |

TABLE 4D
(Data about single lenses)

| Lens | Start surface | Focal length |
|---|---|---|
| 1 | 1 | −196.0942 |
| 2 | 2 | 94.4969 |
| 3 | 4 | 125.1788 |
| 4 | 6 | −23.9205 |
| 5 | 8 | −23.4464 |
| 6 | 9 | 18.9937 |
| 7 | 11 | −29.7725 |
| 8 | 14 | 32.8710 |
| 9 | 16 | −39.4978 |
| 10 | 17 | 19.3818 |
| 11 | 19 | −20.9560 |
| 12 | 21 | 36.6880 |
| 13 | 23 | 41.0898 |
| 14 | 25 | 31.6463 |
| 15 | 26 | −19.0259 |
| 16 | 28 | −38.8589 |
| 17 | 30 | 55.9689 |
| 18 | 32 | −110.0009 |

TABLE 4E
(Data about zoom lens groups)

| | Start | | Lens configuration | Anterior | Posterior |
|---|---|---|---|---|---|
| Group | surface | Focal length | length | principal point | principal point |
| 1 | 1 | 74.91797 | 11.96150 | 2.67440 | 6.72042 |
| 2 | 6 | −13.60299 | 14.34710 | 3.93403 | 8.33209 |
| 3 | 13 | 43.68476 | 14.10870 | −10.77441 | −2.46916 |
| 4 | 21 | 21.01395 | 8.49740 | 3.19484 | 4.70746 |
| 5 | 25 | −48.46814 | 2.81030 | 1.60895 | 2.94889 |
| 6 | 28 | −150.29826 | 4.84570 | −7.39730 | −5.95670 |
| 7 | 32 | −110.00093 | 0.90000 | −0.18152 | 0.26609 |

TABLE 4F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 6 | −0.26393 | −0.40163 | −0.78383 |
| 3 | 13 | 3.10879 | 2.01733 | 1.94873 |
| 4 | 21 | −0.22142 | −0.46586 | −0.51186 |
| 5 | 25 | 1.58936 | 1.79134 | 1.95519 |
| 6 | 28 | 1.16854 | 1.27823 | 1.31643 |
| 7 | 32 | 1.14437 | 1.15379 | 1.27905 |

### Fifth Example of Numerical Values

Following is a fifth exemplary set of numerical values for the imaging optical system corresponding to the fifth embodiment shown in FIG. 5A. Specifically, as the fifth example of numerical values for the imaging optical system, surface data is shown in Table 5A, aspheric surface data is shown in Table 5B, and various types of data in the infinity in-focus state are shown in Tables 5C-5F.

TABLE 5A
(Surface data)

| | | | | | Effective |
|---|---|---|---|---|---|
| Surface No. | r | d | nd | vd | diameter |
| Object surface | ∞ | | | | |
| 1 | 90.03880 | 1.20000 | 1.84666 | 23.8 | 24.419 |
| 2 | 59.49890 | 6.88130 | 1.49700 | 81.6 | 23.425 |
| 3 | −238.02650 | 0.20000 | | | 23.075 |
| 4 | 43.24200 | 4.46730 | 1.49700 | 81.6 | 20.164 |
| 5 | 120.72190 | Variable | | | 19.833 |
| 6 | 100.31340 | 1.00000 | 1.95339 | 32.6 | 13.120 |
| 7 | 18.70010 | 5.60350 | | | 10.817 |
| 8 | −38.17100 | 0.65900 | 1.59300 | 67.1 | 10.401 |
| 9 | 22.99430 | 3.76860 | 1.86737 | 20.3 | 9.581 |
| 10 | −64.91860 | 1.67570 | | | 9.349 |
| 11 | −28.55750 | 0.60000 | 1.88300 | 40.8 | 8.653 |
| 12 | 841.96650 | Variable | | | 8.403 |
| 13 (Aperture) | ∞ | 1.40000 | | | 7.175 |
| 14 | 18.86310 | 3.15490 | 1.53310 | 54.2 | 8.042 |
| 15 | −186.74870 | 2.34810 | | | 8.037 |
| 16 | 18.16240 | 0.60000 | 1.96749 | 31.4 | 7.995 |
| 17 | 12.16800 | 4.48690 | 1.52660 | 57.5 | 7.620 |
| 18 | −56.78280 | 2.02070 | | | 7.457 |
| 19 | −23.01020 | 0.60000 | 1.99774 | 29.3 | 7.087 |
| 20 | 257.24460 | Variable | | | 7.179 |
| 21 | 17.91410 | 2.39390 | 1.49700 | 81.6 | 7.845 |
| 22 | 60.47700 | 1.50600 | | | 7.772 |
| 23 | −151.02030 | 0.95170 | 1.61512 | 62.7 | 7.742 |
| 24 | −67.22120 | 0.20200 | | | 7.740 |
| 25* | 129.48610 | 2.68730 | 1.60699 | 56.2 | 7.666 |
| 26* | −28.96240 | Variable | | | 7.723 |
| 27 | 313.39890 | 2.16870 | 1.94590 | 18.0 | 8.367 |
| 28 | −34.02540 | 0.60000 | 1.81627 | 29.3 | 8.392 |
| 29 | 28.61340 | Variable | | | 8.418 |
| 30 | −19.75750 | 1.00000 | 1.81708 | 43.6 | 11.261 |
| 31 | −57.66910 | 0.57080 | | | 12.677 |
| 32 | 110.58120 | 2.89310 | 1.77513 | 28.6 | 14.789 |
| 33 | −155.85260 | Variable | | | |
| 34 | ∞ | 2.10000 | 1.51680 | 64.2 | |
| 35 | ∞ | 1.00000 | | | |
| 36 | ∞ | BF | | | |
| Image plane | ∞ | | | | |

TABLE 5B
(Aspheric surface data)

25th surface
K = −5.38904E+01, A4 = −3.89899E−05, A6 = 6.61044E−07, A8 = 2.96723E−09
A10 = 1.15167E−10, A12 = −6.86274E−13
26th surface
K = 1.41076E+00, A4 = 4.20336E−05, A6 = 7.19136E−07, A8 = 3.35160E−09
A10 = 1.06972E−10, A12 = −2.50402E−13

(Various Types of Data in Infinity in-Focus State)

TABLE 5C
(Various types of data)
(Zoom ratio: 6.65181)

| | Wide-angle | Middle | Telephoto |
|---|---|---|---|
| Focal length | 28.9871 | 74.7438 | 192.8169 |
| F number | 4.15985 | 5.80061 | 7.38267 |
| Angle of view | 36.7360 | 15.4905 | 6.1953 |
| Image height | 20.6500 | 21.6300 | 21.6300 |
| Total lens length | 112.7959 | 138.0649 | 158.9983 |
| BF | 0.00000 | 0.00000 | 0.00000 |
| d5 | 0.6945 | 19.6632 | 35.3906 |
| d12 | 17.9169 | 9.3631 | 1.7786 |
| d20 | 4.1749 | 2.3141 | 0.8000 |
| d26 | 1.9042 | 3.1688 | 3.6242 |
| d29 | 16.5159 | 16.5350 | 20.0114 |
| d33 | 12.8500 | 28.3448 | 38.6515 |
| Entrance pupil position | 27.5063 | 71.0651 | 142.0332 |
| Exit pupil position | −45.9294 | −59.8930 | −70.5711 |
| Anterior principal point | 38.1990 | 52.4328 | −191.9524 |
| Posterior principal point | 83.8087 | 63.3211 | −33.8186 |

TABLE 5D
(Data about single lenses)

| Lens | Start surface | Focal length |
|---|---|---|
| 1 | 1 | −210.9867 |
| 2 | 2 | 96.5170 |
| 3 | 4 | 133.0191 |
| 4 | 6 | −24.2535 |
| 5 | 8 | −24.1021 |
| 6 | 9 | 19.9742 |
| 7 | 11 | −31.2704 |
| 8 | 14 | 32.3098 |
| 9 | 16 | −40.0794 |
| 10 | 17 | 19.4660 |
| 11 | 19 | −21.1463 |
| 12 | 21 | 50.2766 |
| 13 | 23 | 196.0953 |
| 14 | 25 | 39.2449 |
| 15 | 27 | 32.5473 |
| 16 | 28 | −18.9597 |
| 17 | 30 | −37.2237 |
| 18 | 32 | 83.8487 |

TABLE 5E
(Data about zoom lens groups)

| | Start | | Lens configuration | Anterior | Posterior |
|---|---|---|---|---|---|
| Group | surface | Focal length | length | principal point | principal point |
| 1 | 1 | 76.84915 | 12.74860 | 2.76980 | 7.07585 |
| 2 | 6 | −13.92215 | 13.30680 | 3.58400 | 7.58494 |
| 3 | 13 | 40.29684 | 14.61060 | −10.29737 | −1.79000 |
| 4 | 21 | 21.33848 | 7.74090 | 3.05457 | 4.81994 |
| 5 | 27 | 46.39917 | 2.76870 | 1.71360 | 3.02924 |
| 6 | 30 | −70.09527 | 4.46390 | −2.04382 | −0.44404 |

TABLE 5F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 6 | −0.26280 | −0.40939 | −0.76162 |
| 3 | 13 | 4.29855 | 2.53639 | 2.17021 |
| 4 | 21 | −0.15781 | −0.34228 | −0.46315 |
| 5 | 27 | 1.64350 | 1.81528 | 1.97978 |
| 6 | 30 | 1.28736 | 1.50750 | 1.65549 |

### (Values Corresponding to Inequalities)

Values, corresponding to the inequalities (1) to (15), of the respective examples of numerical values are shown in the following Table 6:

TABLE 6

| | | 1^{st} | 2^{nd} | 3^{rd} | 4^{th} | 5^{th} |
|---|---|---|---|---|---|---|
| | | example | example | example | example | example |
| | | of | of | of | of | of |
| | | numerical | numerical | numerical | numerical | numerical |
| Inequality | | values | values | values | values | values |
| (1) | Th_IS_Obj/Th_G3 | 0.170 | 0.174 | 0.158 | 0.174 | 0.178 |
| (2) | Th_G4_Air/Th_G4 | 0.276 | 0.384 | 0.397 | 0.316 | 0.195 |
| (3) | Th_IS_Img/Th_G3 | 0.149 | 0.134 | 0.135 | 0.138 | 0.153 |
| (4) | (R2_LG3F1 + R1_LG3F2)/ | 0.908 | 0.697 | 0.799 | 0.782 | 0.823 |
| | (R2_LG3F1 − R1_LG3F2) | | | | | |
| (5) | (R2_LG4F1 + R1_LG4F2)/ | −5.053 | −0.514 | −3.004 | 0.433 | −0.428 |
| | (R2_LG4F1 − R1_LG4F2) | | | | | |
| (6) | nd_LG4Fp1 | 1.497 | 1.497 | 1.497 | 1.497 | 1.497 |
| (7) | ThwG5_G6/fw | 0.551 | 0.579 | 0.520 | 0.499 | 0.570 |
| (8) | fG1/fT | 0.401 | 0.383 | 0.403 | 0.389 | 0.399 |
| (9) | fG5/fw | −1.592 | −1.540 | −1.635 | −1.675 | −1.601 |
| (10) | Th_G2_G3/Yw | 0.913 | 0.891 | 0.918 | 0.899 | 0.935 |
| (11) | BFw/Yw | 0.754 | 0.780 | 0.764 | 0.771 | 0.772 |
| (12) | TTLw/Yw | 5.331 | 5.512 | 5.370 | 5.452 | 5.462 |
| (13) | (TTLt − TTLw)/TTLt | 0.291 | 0.291 | 0.295 | 0.291 | 0.291 |
| (14) | Th_IS_Obj/Yw | 0.106 | 0.109 | 0.096 | 0.107 | 0.114 |
| (15) | Th_IS_Img/Yw | 0.093 | 0.085 | 0.082 | 0.084 | 0.098 |

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### INDUSTRIAL APPLICABILITY

The imaging optical system according to the present disclosure is applicable to various types of cameras including digital still cameras, digital cameras, of which the lens is interchangeable, digital camcorders, cameras for cellphones and smartphones, and cameras for personal digital assistants (PDAs), surveillance cameras for surveillance systems, Web cameras, and onboard cameras. Among other things, the present disclosure is particularly suitably applicable to imaging optical systems that are required to provide high image quality such as digital still camera systems and digital camcorder systems.

1. An imaging optical system comprising:
a first lens group having positive power;
a second lens group having negative power;
a third lens group having positive power;
a fourth lens group having positive power;
a fifth lens group having negative power; and
a sixth lens group having power,
the first, second, third, fourth, fifth, and sixth lens groups being arranged in this order such that the first lens group is located closer to an object than any of the second, third, fourth, fifth or sixth lens group is, and that the sixth lens group is located closer to an image plane than any of the first, second, third, fourth, or fifth lens group is,
an interval between each pair of lens groups that are adjacent to each other changing as at least the first, second, third, fourth, fifth, and sixth lens groups move in an optical axis direction aligned with an optical axis of the imaging optical system while the imaging optical system is zooming.

2. The imaging optical system of claim 1, wherein
the third lens group includes:
a group of image stabilizer lenses consisting of a plurality of lenses configured to move perpendicularly to the optical axis during an image stabilization; and
a group of fixed lenses G3Obj located closer to the object than the group of image stabilizer lenses is, consisting of one or more lenses, and configured not to move perpendicularly to the optical axis during the image stabilization, and
the imaging optical system satisfies the following inequality (1):
$$0.06 < Th\_IS \_Obj / Th\_G3 < 0.50 \qquad ( 1 )$$
where Th_IS_Obj is an air gap on the optical axis between the group of image stabilizer lenses and the group of fixed lenses G3Obj, and
Th_G3 is a thickness of the third lens group on the optical axis.

3. The imaging optical system of claim 1, wherein
the fourth lens group includes at least two lenses,
the imaging optical system satisfies the following inequality (2):
$$0.05 < Th\_G4 \_Air / Th\_G4 < 0.80 \qquad ( 2 )$$
where Th_G4 Air is a maximum value of an air gap on the optical axis between adjacent lenses included in at least two lenses that form the fourth lens group; and
Th_G4 is a thickness of the fourth lens group on the optical axis.

4. The imaging optical system of claim 1, wherein
the third lens group includes:
a group of image stabilizer lenses consisting of a plurality of lenses configured to move perpendicularly to the optical axis during an image stabilization;
a group of fixed lenses G3Obj located closer to the object than the group of image stabilizer lenses is, consisting of one or more lenses, and configured not to move perpendicularly to the optical axis during the image stabilization; and
a group of fixed lenses G3Img located closer to the image plane than the group of image stabilizer lenses is, consisting of one or more lenses, and configured not to move perpendicularly to the optical axis during the image stabilization.

5. The imaging optical system of claim 1, wherein
an object-side surface of lens LG3R1 located closer to the image plane than any of other negative lenses that form part of the third lens group has a convex surface facing the image plane.

6. The imaging optical system of claim 1, wherein
the third lens group includes:
a group of image stabilizer lenses consisting of a plurality of lenses configured to move perpendicularly to the optical axis during an image stabilization; and
a group of fixed lenses G3Img located closer to the image plane than the group of image stabilizer lenses is, consisting of one or more lenses, and configured not to move perpendicularly to the optical axis during the image stabilization;
the imaging optical system satisfies the following inequality (3):
$$0.05 < Th\_IS \_Img / Th\_G3 < 0.80 \qquad ( 3 )$$
where Th_IS_Img is an air gap on the optical axis between the group of image stabilizer lenses and the group of fixed lenses G3Img, and
Th_G3 is a thickness of the third lens group on the optical axis.

7. The imaging optical system of claim 1, wherein
the imaging optical system satisfies the following inequality (4):
$$0. < ( R2\_LG3F1 + R1\_LG3F2 ) / ( R2\_LG3F1 - R1\_LG3F2 ) < 1. \qquad ( 4 )$$
where R2_LG3F1 is a radius of curvature of an image-side surface of a lens LG3F1 located closer to the object than any other lens belonging to the third lens group, and
R1_LG3F2 is a radius of curvature of an object-side surface of a lens LG3F2 located adjacent to the lens LG3F1 and closer to the image plane than the lens LG3F1 is.

8. The imaging optical system of claim 1, wherein
an image-side surface of a positive lens LG4Fp1 located closer to the object than any other lens belonging to the fourth lens group has a convex surface facing the object.

9. The imaging optical system of claim 1, wherein
the imaging optical system satisfies the following inequality (5):
$$- 10.0 < ( R2\_LG4F1 + R1\_LG4F2 ) / ( R2\_LG4F1 - R1\_LG4F2 ) < 1. \qquad ( 5 )$$
where R2_LG4F1 is a radius of curvature of an image-side surface of a lens LG4F1 located closer to the object than any other lens belonging to the fourth lens group, and
R1_LG4F2 is a radius of curvature of an object-side surface of a lens LG4F2 located adjacent to the lens LG4F1 and closer to the image plane than the lens LG4F1 is.

10. The imaging optical system of claim 1, wherein
the imaging optical system satisfies the following inequality (6):
$$nd\_LG4Fp1 < 1.6 \qquad ( 6 )$$
where nd_LG4Fp1 is a refractive index of a positive lens LG4Fp1 located closer to the object than any other lens belonging to the fourth lens group is.

11. The imaging optical system of claim 1, wherein
the fifth lens group is configured to move toward the image plane while the imaging optical system is focusing from an infinity in-focus object toward a close-object in-focus state.

12. The imaging optical system of claim 1, wherein
the imaging optical system satisfies the following inequality (7):
$$0.1 < ThwG5\_G6 / fw < 0.8 \qquad ( 7 )$$
where ThwG5_G6 is an interval measured on the optical axis between the fifth lens group and the sixth lens group in the imaging optical system at a wide-angle end; and
fw is a focal length of the imaging optical system at the wide-angle end.

13. The imaging optical system of claim 1, wherein
the imaging optical system satisfies the following inequality (8):
$$0. 2 < fG 1 / fT < 1. \qquad ( 8 )$$
where fG1 is a focal length of the first lens group, and
fT is a focal length of the imaging optical system at a telephoto end.

14. The imaging optical system of claim 1, wherein
the imaging optical system satisfies the following inequality (9):
$$- 2.5 < fG 5 / fw < - 1. \qquad ( 9 )$$
where fG5 is a focal length of the fifth lens group, and
fw is a focal length of the imaging optical system at a wide-angle end.

15. The imaging optical system of claim 1, wherein
the imaging optical system satisfies the following inequality (10):
$$0.5 < Th\_G2 \_G3 / Yw < 3. \qquad ( 10 )$$
where Th_G2_G3 is an air gap measured on the optical axis between the second lens group and the third lens group in the imaging optical system at a wide-angle end, and
Yw is a maximum image height of the imaging optical system at the wide-angle end.

16. The imaging optical system of claim 1, wherein
the imaging optical system satisfies the following inequality (11):
$$0.3 < BFw / Yw < 3. \qquad ( 11 )$$
where BFw is a back focus of the imaging optical system at a wide-angle end; and
Yw is a maximum image height of the imaging optical system at the wide-angle end.

17. The imaging optical system of claim 1, wherein
the imaging optical system satisfies the following inequality (12):
$$2. < TTLw / Yw < 10.0 \qquad ( 12 )$$
where TTLw is a total optical length of the imaging optical system at a wide-angle end; and
Yw is a maximum image height of the imaging optical system at the wide-angle end.

18. The imaging optical system of claim 1, wherein
the imaging optical system satisfies the following inequality (13):
$$0.1 < ( TTLt - TTLw ) / TTLt < 0.5 \qquad ( 13 )$$
where TTLt is a total optical length of the imaging optical system at a telephoto end; and
TTLw is a total optical length of the imaging optical system at a wide-angle end.

19. A camera system comprising:
an interchangeable lens unit including the imaging optical system of claim 1; and
a camera body including: an image sensor configured to receive an optical image of an object formed by the imaging optical system and transform the optical image into an electrical image signal; and a camera mount, the camera body being configured to be connected removably to the interchangeable lens unit via the camera mount,
the interchangeable lens unit being configured to form the optical image of the object on the image sensor.

20. An image capture device configured to transform an optical image of an object into an electrical image signal and display and/or store the electrical image signal thus transformed, the image capture device comprising:
the imaging optical system of claim 1 configured to form the optical image of the object; and
an image sensor configured to transform the optical image formed by the imaging optical system into the electrical image signal.
